(19) United States
(12) Patent Application Publication
(10) Pub. No.: US 2012/0239437 A1
(43) Pub. Date: Sep. 20, 2012

(54) Systems and Methods for Lending Based on Actuarial Calculations

(75) Inventors: Jeffrey J. Harris, Arlington, VA (US); Sean M. Flynn, Claremont, CA (US); Peter G. Lesburg, Bethesda, MD (US); Carlo S. Salerno, Springfield, VA (US); Jeffrey W. Weinstein, Alexandria, VA (US)

(73) Assignee: AFFILIATED COMPUTER SERVICES, LLC, Dallas, TX (US)

(21) Appl. No.: 13/421,830

(22) Filed: Mar. 15, 2012

Related U.S. Application Data
(60) Provisional application No. 61/452,934, filed on Mar. 15, 2011.

(51) Int. Cl. G06Q 40/08; G06Q 40/02

(52) U.S. Cl. 705/4; 705/38

(57) ABSTRACT

The disclosed systems and methods relate generally to techniques for determining the expected cost of a loan repayment program over a given period of time. The systems and methods can calculate a fee for the loan repayment program based on repayment difficulty/non-repayment patterns, underlying economic conditions, and extrapolated enrollment and graduation data.

### CROSS-REFERENCE TO RELATED APPLICATIONS

This application hereby claims priority under 35 U.S.C. section 119(e) to U.S. Provisional Application Ser. No. 61/452,934, entitled “Systems and Methods for Lending Based on Actuarial Calculations,” by inventors Jeffrey W. Weinstein, Jeffrey J. Harris, Carlo S. Salerno, Sean M. Flynn, and Peter G. Lesburg, and filed on Mar. 15, 2011, the contents of which are herein incorporated by reference.

### FIELD OF THE INVENTION

The systems and method described herein generally relate to techniques for determining the expected cost of a loan repayment program over a given period of time.

### BACKGROUND OF THE INVENTION

Loan insurance programs exist to provide borrowers with a loan payment solution in the event that the borrower becomes unable to pay the regularly scheduled loan amount. Often, these programs are based on the particular credit history of individual loan applicants. However, there are numerous situations where the loan applicant has no or only a limited credit history. In other situations, investigation of individual credit histories may be undesirable or impractical.

In these cases, it may be particularly difficult or impossible to accurately calculate the cost of providing a loan insurance product to the applicant. Where limited information is available about individual borrowers, providers of loan insurance programs may rely on generalized data about applicants and financial conditions apart from the applicant's personal financial history.

However, even in situations where there is generalized information about loan applicants and their likely financial conditions, that data is often incomplete. Thus, existing loan repayment insurance programs also suffer from making calculations based on insufficient data, which leads to pricing errors and potential financial losses.

### BRIEF DESCRIPTION OF THE DRAWINGS

FIG. 1 illustrates an example implementation using a computer.

FIG. 2 illustrates an example implementation using a networked computer.

FIG. 3 illustrates an example non-limiting list of possible assumptions and corresponding values.

FIG. 4 illustrates an example rectangular data file comprising public Department of Education data on post-secondary institutions in the U.S.

FIG. 5 illustrates example data parameters describing characteristics of various educational institutions.

FIG. 6 illustrates an example rectangular data file comprising historical overall unemployment, graduate unemployment, and student loan non-repayment data.

FIG. 7 illustrates an example rectangular data file comprising historical income and unemployment rates by year after graduation.

FIG. 8 illustrates an example adjusted non-repayment pattern.

FIG. 9 illustrates an example adjusted non-repayment pattern.

FIG. 10 illustrates an example economic hardship module.

FIG. 11 illustrates an example economic hardship module.

FIG. 12 illustrates an example calculation of an actuarially fair fee.

FIG. 13 illustrates an example calculation of an actuarially fair fee.

FIG. 14 illustrates an example method for calculating enrollments.

FIG. 15 illustrates an example remaining enrollment by year in school calculation.

FIG. 16 illustrates an example method for estimating full-time enrollment by year in college.

FIG. 17 illustrates an example remaining enrollment by year in school calculation.

FIG. 18 illustrates an example method for generating a likelihood of loan non-repayment at a point in time for a given cohort.

FIG. 19 illustrates example two-year cohort default rate data.

FIG. 20 illustrates example cumulative lifetime default rate data.

FIG. 21 illustrates an example extrapolation of cumulative lifetime default rate data.

FIG. 22 illustrates an example extrapolation of delinquencies to time periods after graduation.

FIG. 23 illustrates an example extrapolation of a frequency of delinquency after entering repayment.

FIG. 24 illustrates example deferment and forbearance rates.

FIGS. 25A-25C illustrate example deferment and forbearance indices.

FIG. 26 illustrates an example calculation of a frequency of being in deferment or forbearance for a period of time.

FIG. 27 illustrates an example method of making adjustments based on economic conditions.

FIG. 28 illustrates an example forecast of loan non-repayment based on projected overall unemployment rates.

FIGS. 29A-29F illustrate example regressions based on historical and projected conditions.

FIG. 30 illustrates example calculation curves based on published two-year cohort default rates.

FIG. 31 illustrates an example distribution of wage levels at multiple institutions.

FIG. 32 illustrates an example relationship between average wages and year after graduation.

FIG. 33 illustrates example average and distribution of wage levels and unemployment rates for years after graduation.

FIGS. 34A and 34B illustrate example wage volatility analyses.

FIG. 35 illustrates an example calculation of a percent of unemployed in successive quarters.

FIG. 36 illustrates an example frequency with which college graduates are unemployed or have low wages at various points in a student loan repayment period.

### DETAILED DESCRIPTION

Described herein are systems and methods that can apply an actuarially-based model of annuity non-repayment to loans, and, in particular, to student loans.

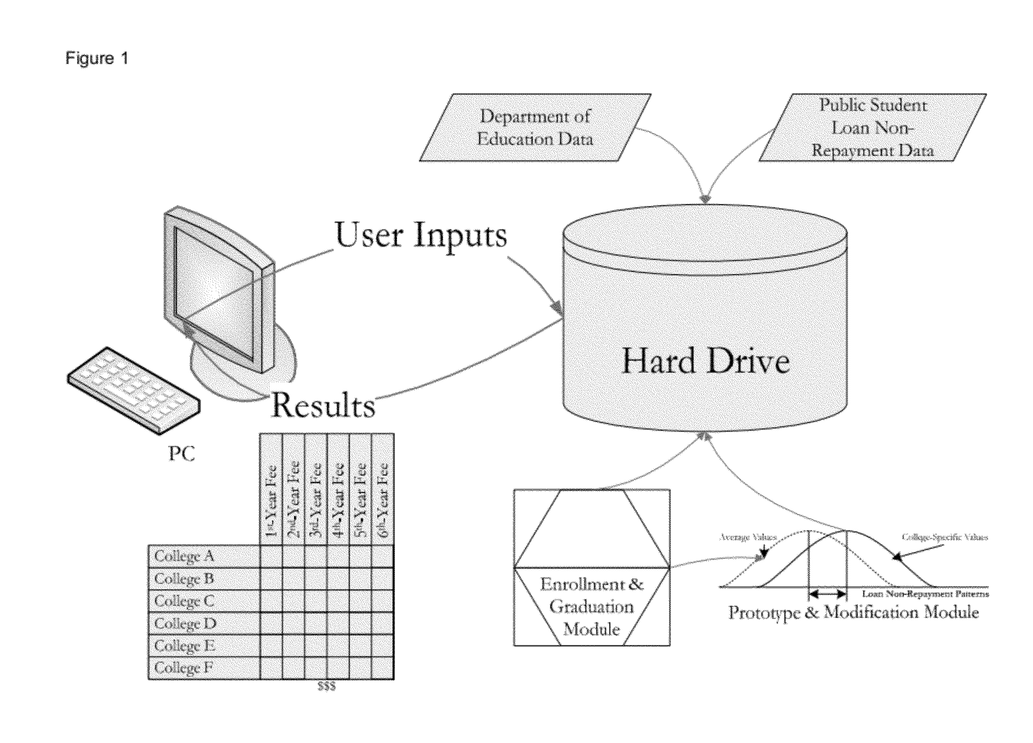

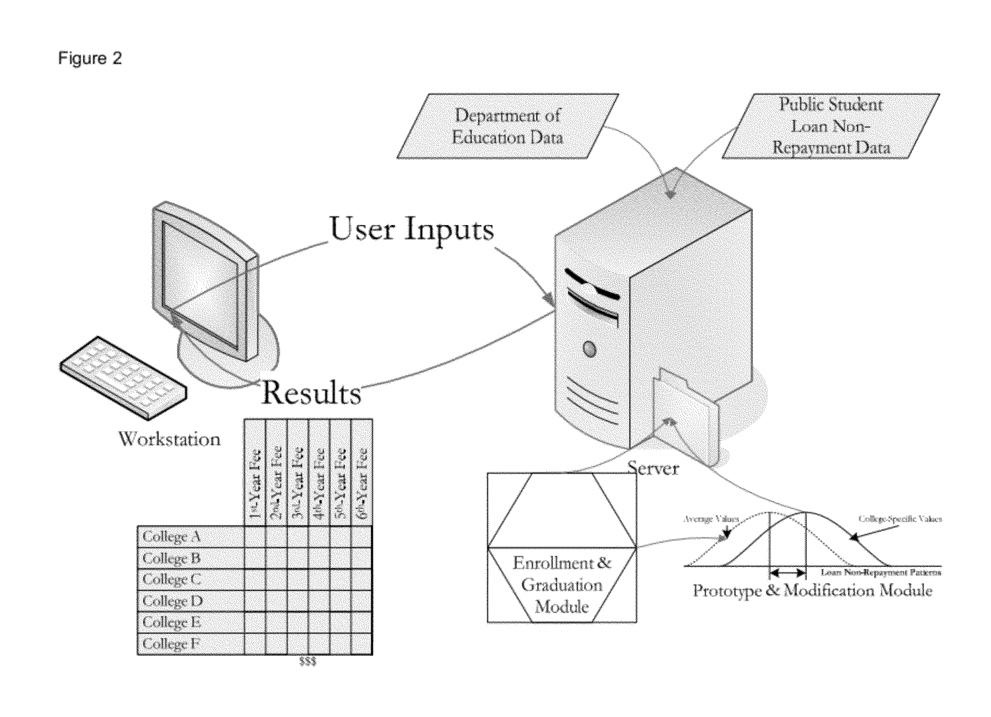

As non-limiting examples, the methods described herein can be implemented in a spreadsheet model, a programming model, such as SAS®, or a combination of the two. Other implementations are possible. The methods described herein could also use a customized calculation engine operating in hardware or software, or a combination of hardware and software, that uses these methods to yield the results described here. As such, the methods described herein are not software-specific. An example implementation may be on a computer, as illustrated in FIG. 1. The methods described herein can also be performed on a network system, as illustrated in FIG. 2. The data created, used, or otherwise referenced by the methods described herein can be stored on a data storage device in the data processing system. Example systems and methods for implementing the methods described herein are presented below.

As a non-limiting example, the models described herein can calculate the average net present value of the cash flows associated with providing a student loan repayment program (SLRP). In some embodiments, the SLRP can be an interest-free line of credit that covers student loan repayments in the event that student borrowers find themselves in financial hardship during their student loan repayment period. This average net present value can then serve as the actuarially fair, up-front fee that could be charged for the SLRP. In some embodiments, any fees above this amount could generate profit to the firm providing the SLRP.

As used herein, actuarially fair insurance can have an expected net pay-off of zero. From the insured's point of view, an insurance contract is actuarially fair if the premiums paid are equal to the expected value of the compensation received. The expected value may be defined as the probability of the insured-against event occurring multiplied by the compensation received in the event of a loss.

In some embodiments, this benefits loan recipients because it guarantees that their underlying obligations can continue to be paid, thereby maintaining a positive credit record and potentially reducing their outstanding principal balance. In some embodiments, loan recipients are not faced with capitalized interest penalties because the line of credit can be configured to operate with a 0% interest rate. In some embodiments, the line of credit may come with an interest rate that, while not 0.000%, is substantially or approximately zero percent. While these techniques are applicable to student loans, they can also be applied to any form of annuitized (or regular) payments to a third party. As non-limiting examples, users of the described systems and methods could be individual borrowers or loan recipients, retail banking operations, and/or lender partners.

The methods described herein improve over known methods in at least two respects. First, for an implementation providing a SLRP version of this product, complete public information on the potential customer base (students) is generally incomplete. The methods described herein can be configured to determine the enrollment and graduation characteristics of students for some or all of the years in a post-secondary institution, by institution, based on publicly available data. Second, if there is limited publicly available data on the likelihood that individuals from a given institution in their student loan payment period may be in financial hardship, the methods described herein can be configured to use publicly available data to derive an actuarially fair, up-front fee for the SLRP for students, by institution. In some embodiments, this derivation can be based in part on the administrative data for institutions commonly required and published by federal education agencies and/or the federal government.

In some embodiments, the characteristics of the loan applicants can be determined using various methods, such as the methods presented in the enrollment and graduation modules described below. The actuarially fair, up-front fees can then be determined by taking the output of the enrollment and graduation modules in combination with either or both of two other modules, or another suitable alternative:

1. The prototype loan non-repayment and prototype modification combined module used to determine the likelihood of non-repayment at any point in time after graduation.

2. The economic hardship module used to determine the likelihood that a college graduate can have student loan payments that are greater than or equal to 10% of their adjusted gross income (AGI).

By taking the output of the enrollment and graduation modules in combination with either or both of the two other modules described above, the net present value of the expected draws from the line of credit associated with the above likelihoods can be used as the actuarially fair fee for student borrowers at the post-secondary institutions.

The prototype loan repayment difficulty/non-repayment and prototype modification module and the economic hardship module may produce equivalent or substantially equivalent results in some cases. Several studies have suggested that student borrowers begin to have difficulty making their student loan payments when those payments reach approximately 10% of their adjusted gross income (AGI). Thus, if 20% of borrowers are observed being unable to make their loan payments, then, effectively, 20% of borrowers have student loan payments that are about 10% of their AGI, and vice versa. As a result, in some embodiments, these two methods can be employed in tandem for mutual corroboration.

In some embodiments, users can be prompted to input multiple assumptions and parameters according to which the models are to be run and the calculations performed. These input prompts can include, but are not limited to, the following example queries:

1. Number of payments to be covered by the SLRP. Can it be used to cover all annuitized payments? Or, for example, can it be used to cover just one year's worth of payments?

2. Coverage period beginning and end. Can the borrower use the SLRP to cover payments throughout the student loan repayment period? Or does the SLRP only cover specific years?

3. Underlying loan characteristics. What is the interest rate charged by the student loan lender? What is the student loan repayment period? Are student loan payments applied at the beginning or end of a billing period? Should the model calculate the actuarially fair, up-front fees based on the loan amounts typically held by students at the colleges? Or should the fees reflect a standardized loan amount? And, if so, what is this standardized amount?

4. Economic conditions. What are the projected national or college-graduate unemployment rates over time? What are the projected inflation rates while the purchaser is in school and while the purchaser is in repayment?

5. Discount rate. How should future cash flows be discounted to generate the actuarially fair fees?

6. Adverse selection/moral hazard. Is a representative sample of student borrowers expected to purchase the SLRP? Or are the borrowers who are more likely to be in financial hardship also more likely to purchase the SLRP?

7. Fee charged to purchasers. Can the fee charged be larger than the actuarially fair, up-front fee? Can there be a minimum fee? Can the fee be scaled up by a factor? Can a fixed level of profit be added to the fee?

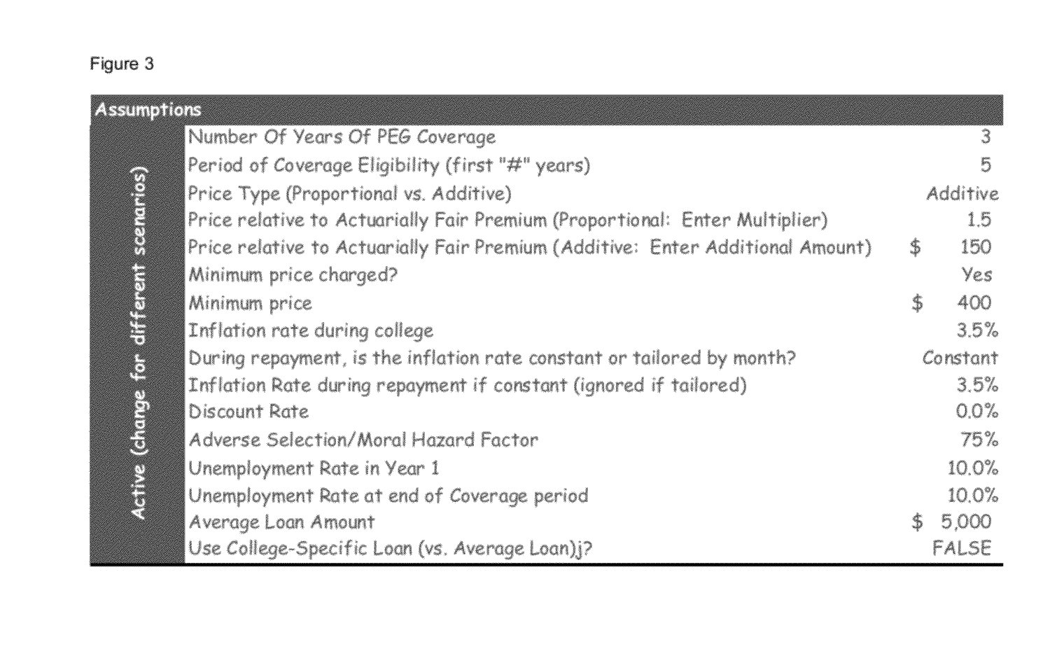

An example, non-limiting list of possible assumptions and corresponding values is presented in FIG. 3. The assumptions data provided by the user can either be acquired by prompting the user with a display prompt, or it may be acquired by loading the assumptions data from an existing data file, or the assumptions data may be acquired by another batch process. The assumption data can be provided to the processor by any input means, such as a preconfigured file or other database, without prompting the user.

In some embodiments, the models can then use additional data files to generate the results. The additional files can be of various formats and from various sources.

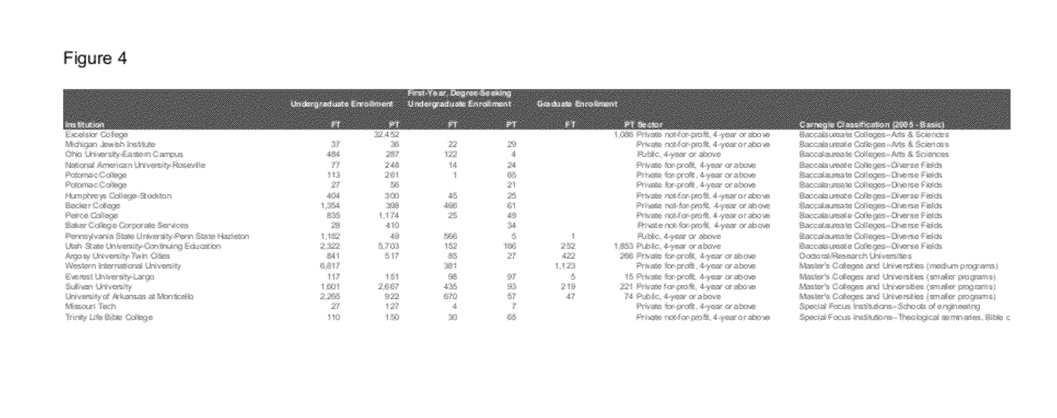

As a first example, an additional data file could be a data file comprised of public Department of Education data on the post-secondary institutions in the U.S. This data file can include such information as any or all of total student enrollment, enrollment in Year 1 of a program, transfer students before Year 2, excluded students (e.g., students who have ceased enrollment to engage in military service), enrollment retention, overall graduation rates, graduation at specific points in time, college characteristics (e.g., publicly-owned versus privately-owned, two-year versus four-year, location), the proportion of students with student loans, average loan amounts, and the two- or three-year, cumulative cohort default rates on those loans. Such an example is illustrated in FIG. 4.

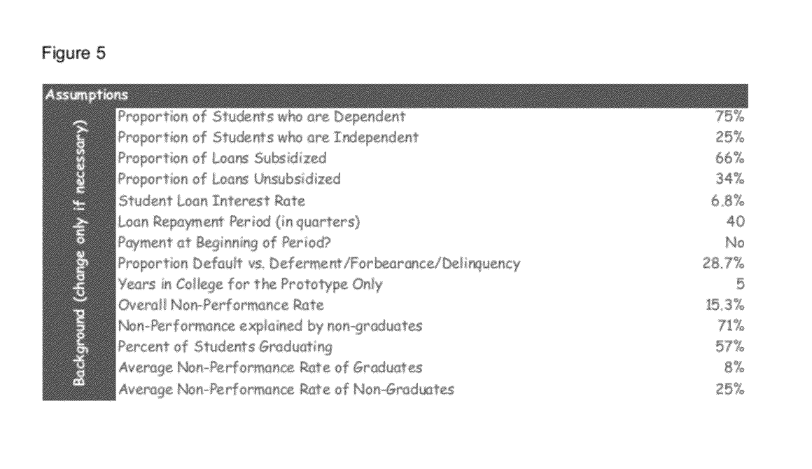

As a second example, a separate data file can be used that includes aggregate items such as the typical college enrollment duration for full-time students (if this is to be used as an override factor in place of typical enrollment by college), the ratio of dependent to independent students, loan limits for dependent and independent students, the national average graduation rate, the relative frequencies of student loan non-repayment by college graduates versus non-graduates, and the relative proportion and aggregate levels of the different forms of student loan non-repayment (if that is to be used as an override). Such an example is illustrated in FIG. 5.

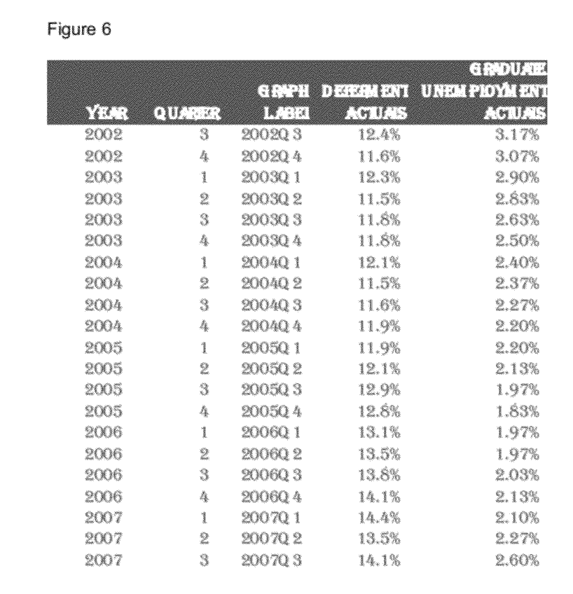

As a third example, a separate data file containing historical overall unemployment, graduate unemployment, and student loan non-repayment data used by the models to analyze relationships can be used. An example is illustrated in FIG. 6.

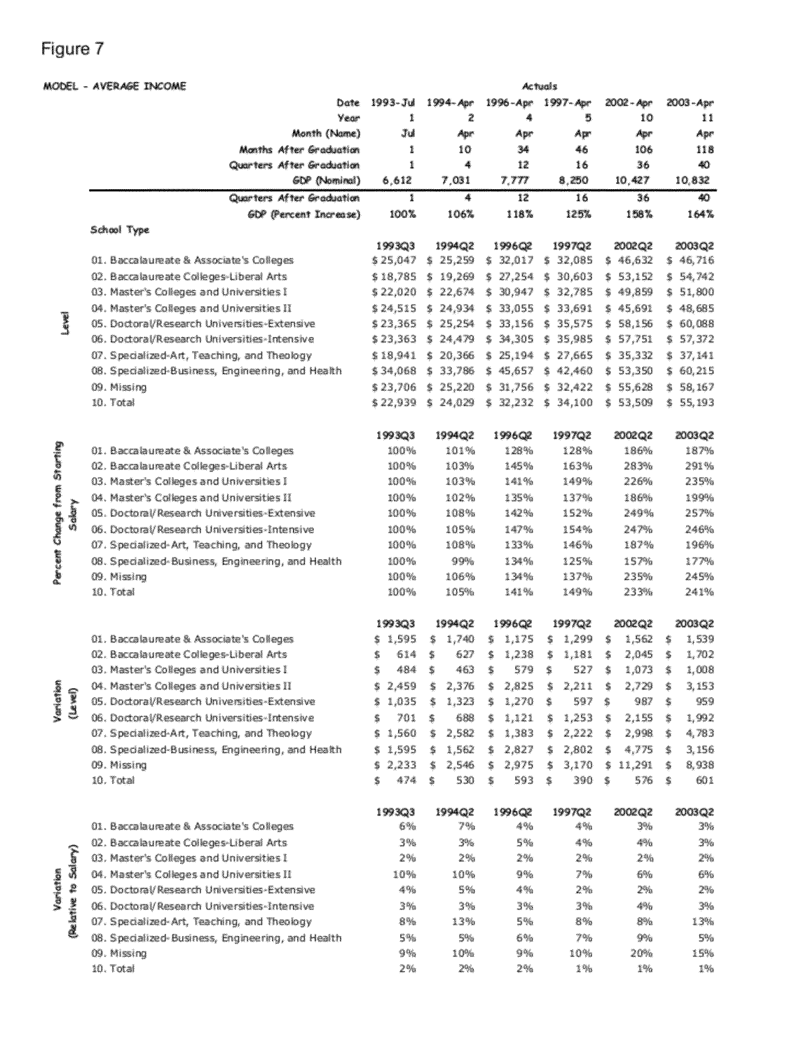

As a fourth example, a data file containing historical income and unemployment rates by year after graduation, as published in Department of Education studies, can be used. An example is illustrated in FIG. 7.

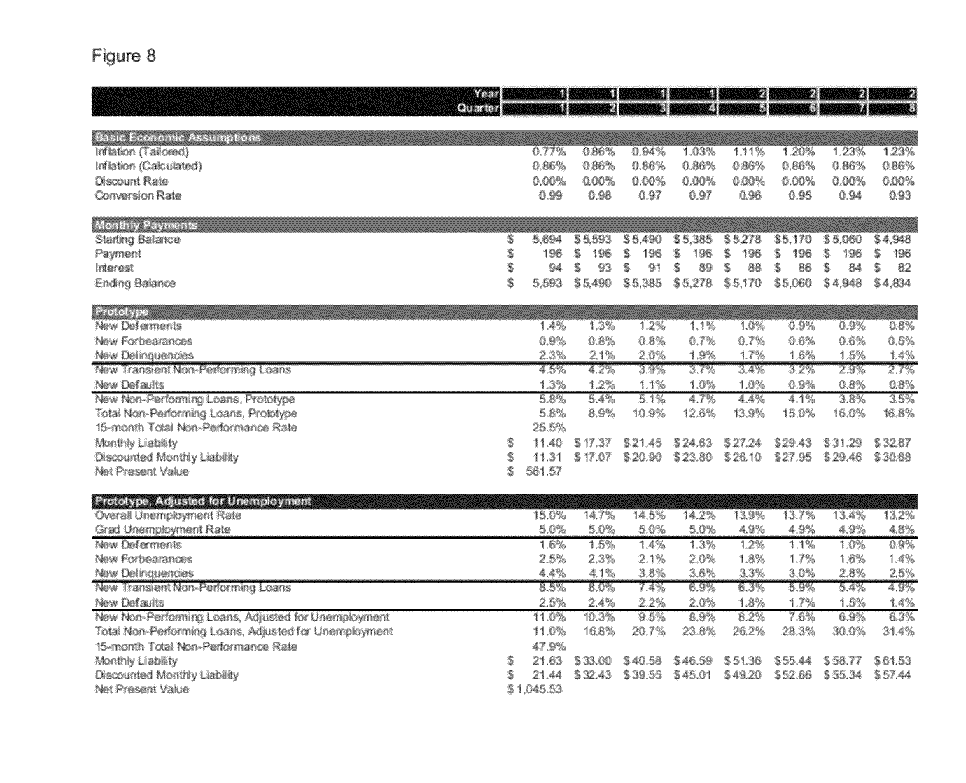

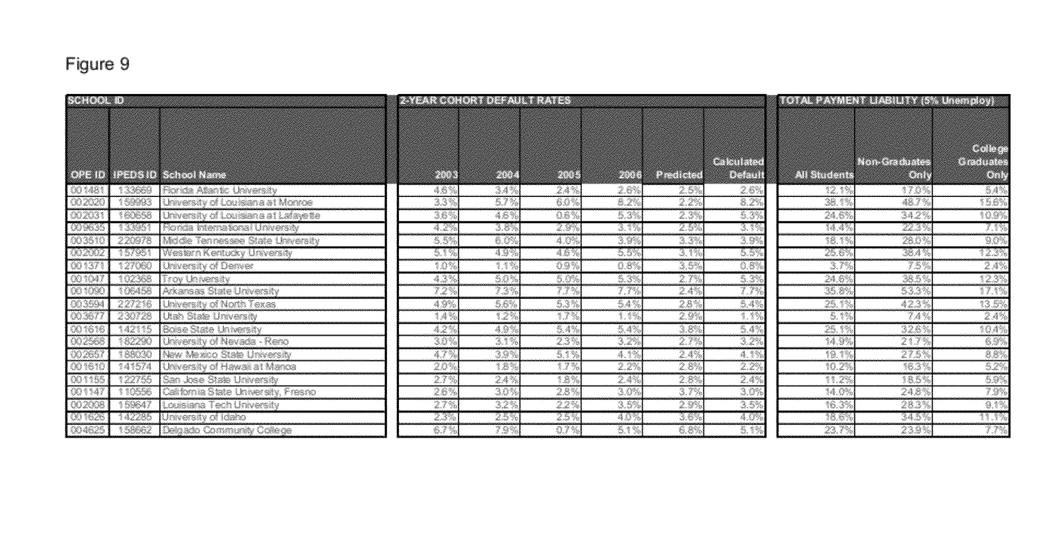

Using these data files, the loan non-repayment module can generate a prototype repayment difficulty/non-repayment pattern, adjust it based on the underlying economic conditions, and then adjust the resultant pattern based on college characteristics. An example of a prototype non-repayment pattern so adjusted is illustrated in FIGS. 8 and 9.

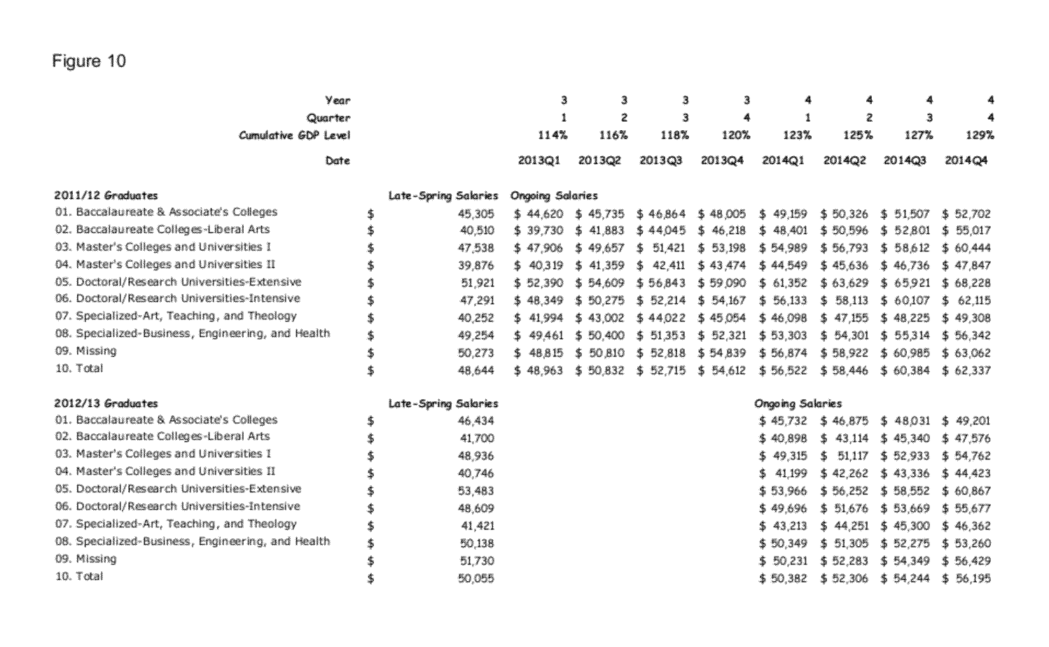

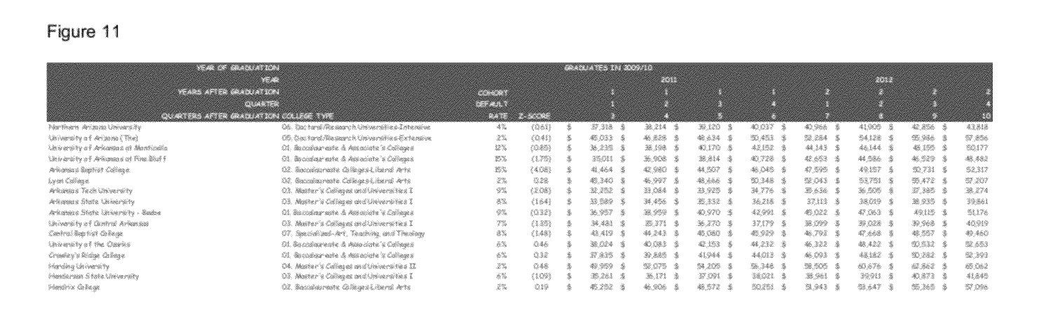

Alternatively, or in combination with the prototype non-repayment module, the economic hardship module can be configured to generate projected income and unemployment rates by graduation/drop-out cohort and year after leaving the institution, which can subsequently be used to determine the proportion of borrowers with an income below a threshold, or unemployed, at any point after leaving the institution. An example of an economic hardship module is illustrated in FIGS. 10 and 11.

The prototype loan repayment difficulty/non-repayment and prototype modification module and the economic hardship modules can be configured to generate the information used to determine the fees to charge for the provision of this line of credit, including expected draws on the line of credit during the draw period. This, in turn, can be based on the enrollment, graduation, income, and other modules specific to student borrowers.

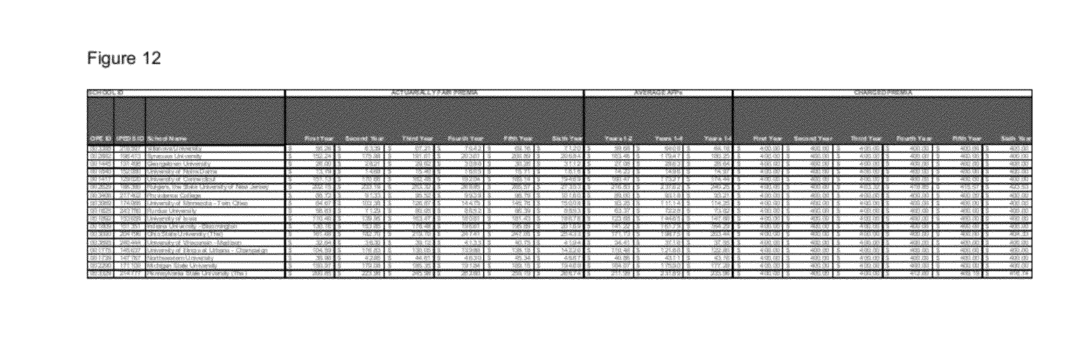

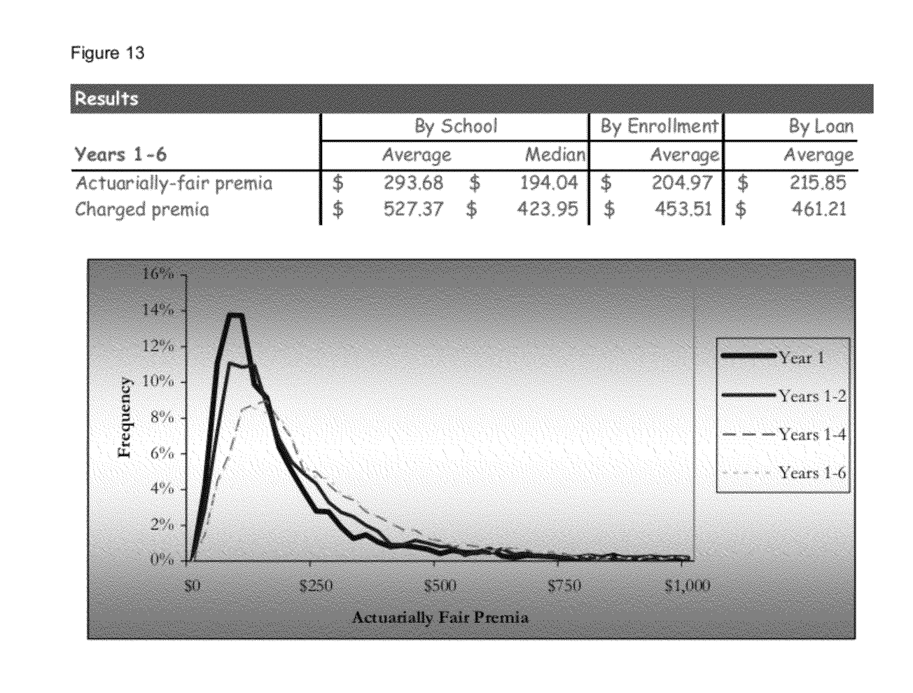

The prototype repayment difficulty/loan non-repayment and prototype modification modules and the economic hardship module can be configured to generate any or all of student enrollment calculations, student graduation rate calculations, an actuarially fair fee, and a charged fee for the institutions and for the years in school separately. The modules can also be configured to generate corresponding or equivalent aggregate figures. For example, the modules can be configured to output the actuarially fair and charged fees for students at College A for first-year students, second-year students, and so on. The modules can also be configured to output the average actuarially fair fee weighted by enrollment at College A to show what the overall fee charged would be. This information can then be used by financial models to predict customer uptake, cash inflows, and cash outflows for any subset of colleges or for the nation as a whole. By changing the underlying assumptions—as in a Monte Carlo simulation—the modules described herein can be used to generate a distribution of the actuarially fair and charged fees by college and in aggregate. Example calculations are illustrated in FIGS. 12 and 13.

In some embodiments, the (positive) net present value of the repayment of the line of credit in later years can be calculated using standard financial discounting. This can include payments made to repay on the line of credit during the repayment period. This, in turn, can be based on industry-wide rules of thumb, and/or user preference, with respect to the likelihood and timing of repayment and other general consumer-based analyses. Thus, the overall actuarially fair fee that could be charged for the firm providing this product to break even can be determined.

In some embodiments, the net present value of the obligation can be calculated by summing the net present value of the expected cash outflows and the net present value of the expected cash inflows. The net present value of the expected cash outflows may be a positive number because the more draws a borrower is likely to take, the greater the obligation. The net present value of the expected cash inflows may be negative number because the more inflows/repayments there are, the smaller the obligation.

In some embodiments, a processor can then calculate an actuarially fair premium by taking the expected draws on the line of credit during the draw period and subtracting the expected payments made to repay on the line of credit during the repayment period to generate a net obligation, which can then be discounted to the purchase time (years earlier) to generate the actuarially fair premium.

The expected cash outflows are the expected draws on the line of credit to be taken by a borrower and, in some embodiments, may be directly related to the expected hardship/delinquency pattern, which is discussed herein. In some embodiments, the net present value calculation can take into consideration when those draws may be made relative to when the line of credit is acquired or secured (e.g., when the plan is purchased). In some embodiments, borrowers can only draw on their line of credit when they are in their loan repayment period, which typically starts 6 months after they have dropped below half-time enrollment (or dropped out of school, or graduated) and that the line of credit would be acquired at the beginning of a loan term. Thus, the expected time left in school can be calculated, and this can be based on the enrollment patterns at each school separately. For entering students, the average length of their in-school period may be the average time spent in school across some or all students.

For example, if 1000 students enter an institution with a particular cohort in a two-year program and finish that first year, but only 500 students complete their second year, the average time in the program may be ((500 students)*(1 year)+(500 students)*(2 years))/1000 students=1.5 years. Using enrollment data collected and published by the Department of Education, a processor can be configured to calculate these different enrollment patterns to reflect the specific enrollment/completion patterns at each institution.

For example, to calculate the net present value of cash flows starting 6 months after leaving this hypothetical school, the net present value of the obligations of a line of credit acquired upon entering school would be discounted by 1.5 years+6 months=2 years for the expected value of the first payment, 2 years and 1 month for the expected value of the second payment, 2 years and 2 months for the expected value of the third payment, and so on. Then, given a fixed 5-year draw window and an immediate repayment obligation on the part of the borrower at the end of that time, the net present value of the cash inflows would be discounted by 2 years+5 years=7 years for the expected value of the first repayment, by 7 years and 1 month for the second repayment, and so on.

The standard net present value formula can be used, having the form NPV=Expected Cash Flow/(1+discount rate)^{t}, where t is the time in the future when the payment would occur. For example, for a first payment obligation that would occur 2 years after the line of credit is acquired, assuming a 5% discount rate and a $100 expected draw on the line of credit, the net present value of that draw would be $100/(1.05)²≈$90.70. In some embodiments, all net present values across all draws and repayments can be summed to generate the overall net present value of the line of credit obligation. This resulting value would be the actuarially fair premium that may be charged by the provider of the line of credit for the provider to expect to break even. In other embodiments, fewer or greater than all net present values and draws can be used.

For example, if the average net present value of expected draws on the line of credit under certain economic assumptions is $215.85, and the average net present value of repayment of the line of credit after a student's loan term is $75.15, then the overall actuarially fair rate would be $215.85−$75.15=$140.70. So, the firm could charge, among other values, either the $215.85 or the $140.70 fees, depending on whether it expects the draws to be actually repaid.

As used herein, the average net present value can be the weighted average net present values of the cash flows at an institution across the different borrower cohorts. While these models are readily applicable to student loans, they can also be applied, with different data, to other annuities and loans, such as car loans, house payments, and other payment plans.

As discussed herein, the process of calculating an actuarially fair premium can include calculating various intermediate values. For example, the actuarially fair premium can be considered to be several outputs if different classes of borrowers are separated. If the model assesses the net present value of the obligation for first-year students vs. second-year students, then the processor could use the model for two outputs. Alternatively, if the processor is assessing the net present value for students at an institution more generally, the value could, for example, be one number, that could be the average of the first- and second-year net present value calculations, weighted by their proportion of the overall enrollment at the institution, or by their expected take-up patterns in terms of acquiring the line of credit, or weighted by some other means. The models described herein can be configured to calculate various types of intermediate data which can then be used by the models. Example types of intermediate data are described below. Some embodiments can use some, all or none of the example types of intermediate data described.

Enrollment and Graduation—Four-Year Colleges

Enrollment and graduation data for four-year colleges can be used, in some embodiments, to estimate full-time enrollment by year in school, by institution, using publicly available information. Because there may be only detailed public information on overall and first-year full-time undergraduate enrollment, information on retention in the second year of college, transfer rates, life-event dropout rates, graduation rates, and enrollment trends can be used to extrapolate enrollment figures beyond the first year.

As a non-limiting example, data can be sourced or derived from the National Center for Education Statistics' (NCES) Integrated Postsecondary Education Data System (IPEDS), which requires Title IV institutions (e.g., institutions providing Stafford loans, Pell Grants, and other sources of federal financial aid) to provide annual institutional and student information, and other NCES studies.

Various types of data may be known, including, for example, overall undergraduate enrollment for multiple colleges; enrollment in year 1 for multiple colleges; transfer and life-event dropout rates after year 1 and overall for multiple colleges; retention in year 2 for non-transfer, non-life-event dropout students for multiple colleges; graduation rates overall and in years 4, 5, and 6 for non-transfer, non-life-event dropout students for multiple colleges; and/or overall transfer frequency of college graduates for a sample of students.

Some types of data may not be known, including, for example, graduation rates in years 4, 5, and 6 for multiple students; and/or student enrollment in years 2-6.

The example methods described herein can be used to estimate the number of full-time students from any given entry cohort (e.g., Year 1 enrollees) who continue their enrollment in Bachelor's programs in Years 2-6, regardless of whether they continue their educations at the same institution or not, and how many graduate in Years 4-6. This could also be applied to part-time students.

This method utilizes the detailed information on full-time students at the beginning and end of their college careers to interpolate enrollment in the intervening years. As a non-limiting example, this can is done in two steps: 1. Calculate the percentage of students remaining from Year 1 in Years 2-6. 2. Apply these percentages to overall enrollment to generate total student counts.

For example, the enrollment percentage in Year 1 can be fixed at 100% by definition. For the full-time enrollment percentage in Year 2, colleges report the percentage of students who transfer or are no longer enrolled as a result of a life event (e.g., death, military service) during or immediately after Year 1, and the Year 2 student retention rate for some or all remaining students. For the full-time enrollment percentages at the end of college, this method takes advantage of the fact that the vast majority of students who do not complete their degree programs drop out in the first half of these programs. Thus, the full-time enrollment percentages in Years 4, 5, and 6 should closely match the graduation rates in those same years, which IPEDS also requires colleges to submit. Full-time enrollment beyond Year 6 may be less relevant because of the scarcity of undergraduate programs that can take more than six years to complete with full-time enrollment, but those data could be used if it were advantageous to do so.

Because the enrollment rates for Years 2-6 exclude transfer students, the proportions may be adjusted by these transfer students to accurately reflect their true respective measures. This can be accomplished under either of two different assumptions:

Assumption 1: Transfer students resemble the overall entering class. Transfer students may resemble the entering cohort because a student's first college should reflect his or her general likelihood of completion, so his or her destination college on average should be similar in quality to his or her originating college and, therefore, yield similar graduation rates. While some students may transfer to colleges that have higher graduation rates or that yield higher expected incomes upon graduation, others may transfer to colleges that have lower performance levels in these regards, and this assumption predicts that these two changes in quality can cancel each other out. Under this assumption, the method described herein would apply the IPEDS graduation rate to the entire entering class as the overall graduation rate.

Assumption 2: Transfer students differ from the overall entering class. Transfer students are either more or less likely to graduate than the students who remain. An example way to determine which of these two cases is true is to compare the percentage of students who transfer to the percentage of some or all graduates who transferred. Transfer rates are collected by IPEDS, and NCES has conducted several studies on graduate characteristics, including how many colleges have been attended by graduates. If the percentage of students who transfer, as reported in IPEDS, is less than the percentage of graduates who transferred, as reported in the NCES studies, then transfer students have a greater likelihood of graduation than non-transfer students, and vice versa. Under this assumption, the method described herein can be configured to use this difference as a scaling factor to be applied to the transfer students in calculating an overall graduation rate. The graduation rate of transfers can be calculated as follows:

$${\hat{G}}^{T} = \frac{{P}^{T}}{{P}^{C}} \times \frac{{E}^{C}}{{E}^{T}} \times {G}^{C}$$

where
   G^{t}=graduation rate of transfers, from NCES studies,
   G^{c}=graduation rate of continuing students, from IPEDS,
   P^{t}=proportion of graduates who were transfer students, from NCES studies,
   P^{c}=proportion of graduates who attended only one college, from NCES studies,
   E^{t}=proportion of Year 1 enrollees who transferred, from IPEDS,
   E^{c}=proportion of Year 1 enrollees who did not transfer, from IPEDS,
   ̂=designates unknown values

The overall graduation rate would then be calculated as follows:

OverallGraduationRate=Ĝ^{O}=E^{C}×G^{C}+E^{T}×G^{T}

The full-time enrollment percentage in Year 3 can be calculated as an interpolation between the Year 2 and Year 4 enrollment percentages. This can be a linear interpolation (e.g., average of Year 2 and Year 4), a geometric interpolation (e.g., Year 2/Year 3=Year 3/Year 4), or the solution (P₃) to the following equation:

E_{Y}^{T}=E_{Y}¹+E_{Y-1}¹×P²+E_{Y-2}¹×\hat{P}³+E_{Y-3}¹×P⁴+E^{Y-4}¹×P⁵+E_{Y-5}¹×P⁶

where
E^{t}_{y}=the observed IPEDS total enrollment count in year y,
E¹_{y}=the observed IPEDS Year 1 enrollment count in year y,
Pⁱ=the calculated proportion of enrollees remaining in their i^{th} year, i≠3,
̂=designates unknown values

This can be observed for multiple years (e.g., values of “y”) to generate a stable Year 3 enrollment percentage or can be run as a series of simultaneous equations based on multiple values of “y” if there is a trend change in the percentage enrollments for the years in college.

Similar to solving the system of equations for the Year 3 proportion alone, an alternative method of calculating the percentage of remaining students in some or all years in college is to take advantage of the fact that IPEDS has existed for several years and use the multiple observations of the same IPEDS variables to generate the enrollment percentages. Because IPEDS includes both entering classes and degrees awarded in multiple years, the method described herein can analyze the simultaneous equations that cover multiple years to determine the ratio of degrees awarded in Years 2-6. For example, the number of enrollees in any given year can equal the number of students who entered college that year+the number of students who entered college one year earlier times the proportion remaining in the second year+the number of students who entered college two years earlier times the proportion remaining in the third year and so on. This yields the following system of equations:

$$…$$

$${E}_{Y}^{T} = {E}_{Y}^{1} \times 100 \% + {E}_{Y - 1}^{1} \times {\hat{P}}^{2} + {E}_{Y - 2}^{1} \times {\hat{P}}^{3} + {E}_{Y - 3}^{1} \times {\hat{P}}^{4} + {E}_{Y - 4}^{1} \times {\hat{P}}^{5} + {E}_{Y - 5}^{1} \times {\hat{P}}^{6} + {E}_{Y - 6}^{1} \times {\hat{P}}^{7} …$$

$${E}_{Y - 1}^{T} = {E}_{Y - 1}^{1} \times 100 \% + {E}_{Y - 2}^{1} \times {\hat{P}}^{2} + {E}_{Y - 3}^{1} \times {\hat{P}}^{3} + {E}_{Y - 4}^{1} \times {\hat{P}}^{4} + {E}_{Y - 5}^{1} \times {\hat{P}}^{5} + {E}_{Y - 6}^{1} \times {\hat{P}}^{6} + {E}_{Y - 7}^{1} \times {\hat{P}}^{7} …$$

$${E}_{Y - 2}^{T} = {E}_{Y - 2}^{1} \times 100 \% + {E}_{Y - 3}^{1} \times {\hat{P}}^{2} + {E}_{Y - 4}^{1} \times {\hat{P}}^{3} + {E}_{Y - 5}^{1} \times {\hat{P}}^{4} + {E}_{Y - 6}^{1} \times {\hat{P}}^{5} + {E}_{Y - 7}^{1} \times {\hat{P}}^{6} + {E}_{Y - 8}^{1} \times {\hat{P}}^{7} …$$

$$…$$

where
   E^{t}_{y}=total enrollment in year y,
   E¹_{y}=entering students in year y,
   Pⁱ=proportion of entering students remaining in their i^{th} year, Pⁱ≦1,
   ̂=designates unknown values

This yields a system of equations with as many unknowns as the number of proportions that are to be estimated, so the IPEDS values can be used to complete that same number of equations to solve for that number of unknowns. For example, if P₇₊=0 because no full-time students can remain in college beyond six years, then there are five unknowns, and the processor can make five observations of total enrollment and ten observations of entering students to solve for the desired proportions. In some embodiments, the processor also adds trend factors to the proportions P, and the trend factors would include another year of observation to be analyzed. For example, if the processor adds a trend factor to P₂ so that P₂ becomes P₂, P₂+R, P₂+2R, P₂+3R, and so on as years are spanned, then this new unknown trend variable “R” would indicate the examination of one further equation/observation. The processor could then be configured to make the standard adjustments for transfer students to generate the final remain-in-college percentages for some or all students in the entering classes, as discussed above.

Some colleges only report partial information, such as overall, full-time undergraduate enrollment only. The pieces of information used for this method can be (1) overall enrollment, (2) retention in Year 2, and (3) some form of graduation information. If the processor is provided with this information, then the other information necessary for calculating the enrollment figures can be created using the general patterns for missing data for institutions of the same type, as designated by Carnegie Classification, location, sector, and other institutional factors. For example, if a college's only reported graduation rate was an overall rate of 40%, but institutions of the same type had graduation rates of 30%, 15%, and 5% in Years 4, 5, and 6, respectively, then the processor could calculate a Year 4 graduation rate of (40%)*(30%)/(30%+15%+5%)=24%, a Year 5 graduation rate of (40%)*(15%)/(30%+15%+5%)=12%, and a Year 6 graduation rate of (40%)*(5%)/(30%+15%+5%)=4%, which sum to 40%.

For enrollment in Year 1, IPEDS requires colleges to provide full-time student enrollment in Year 1, and this serves as the anchor for the rest of the calculations. For enrollment counts in Years 2-6, the processor can be configured to apply the enrollment percentages in those years to the Year 1 enrollment. This may not sum to the total enrollment count of the college because this overall count is a snapshot that captures students in different years from different cohorts. For example, if enrollment is increasing from year to year, then total enrollment would be less than the figure calculated under this method because it would reflect older cohorts that had smaller entering classes.

To measure the proportion of enrollees in classes for the currently-observed total student enrollment (rather than what a given entering class can look like in future years) the processor can be configured to use the above method as a basis and then adjust the proportions based on previous enrollment patterns. For example, if it is assumed that the proportion of entering students remaining in future years is stable/constant, then the processor could be configured to adjust the overall enrollment count that results from the above analysis by using the size of the entering class in a past year rather than a previous year. This results in the following adjustment equation:

E_{Y}^{I}=E_{Y-I+1}¹×\hat{P}^{I}
where
   Eⁱ_{y}=enrollees in their i^{th} year in college in year y,
   Pⁱ=proportion of entering students remaining in their i^{th} year, Pⁱ≦1
   ̂=designates unknown values

The processor could be configured to then scale the resultant counts other than for the first year up or down so that the sum of the enrollees by year in college is equal to the total full-time count for that year. Alternatively the processor could be configured to adjust the proportions of students remaining in a year to yield the same result:

$${\hat{P}}_{Y}^{I} = {P}^{I} \times \frac{{E}_{Y - I + 1}^{1}}{{E}_{Y}^{1}}$$

where
   Eⁱ_{y}=enrollees in their i^{th} year in college in year y,
   Pⁱ=general proportion of entering students remaining in their i^{th} year, Pⁱ≦1,
   Pⁱ_{y}=specific proportion of entering students remaining in their i^{th} year in year y,
   ̂=designated unknown values

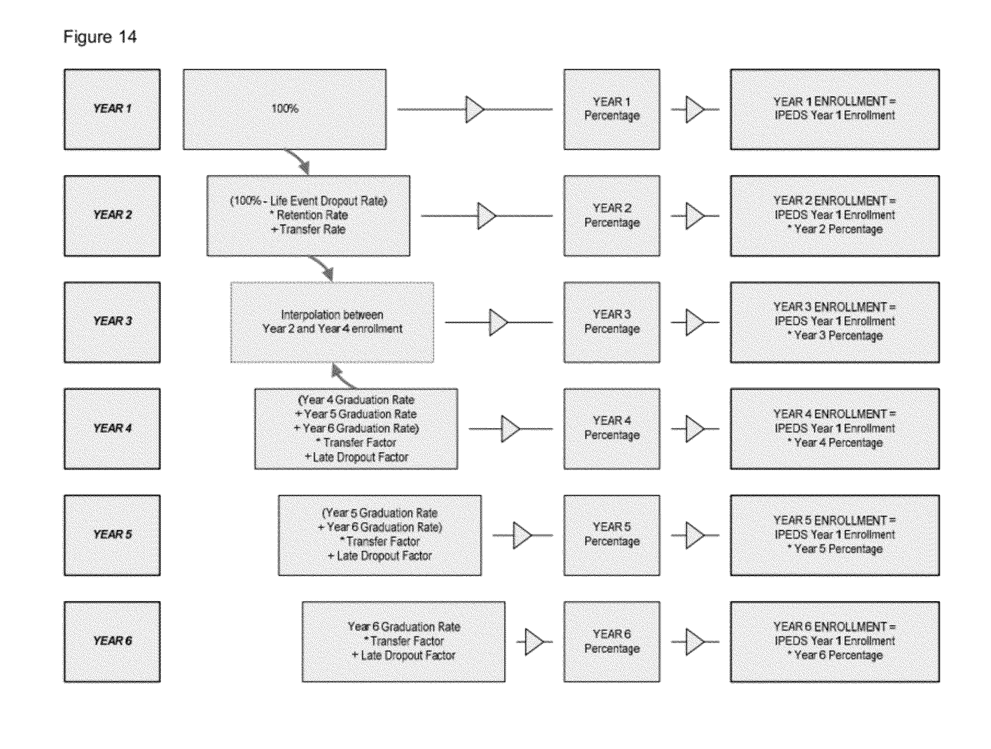

These derived enrollment and graduation rates by year in college are then used by the actuarial models in the processor to determine the actuarially fair fees because the likelihood and timing of enrollment and graduation are used. These derived rates can also be used by the financial model to characterize the potential customer base. An embodiment of this enrollment and graduation calculation method can be summarized in the flow chart in FIG. 14.

An example data calculation is presented below. If the selected NCES study has transfers as 20% of Year 1 enrollment but 25% of graduates and a college has the following reported information:

Overall Enrollment=2,500

Year 1 Enrollment=1,000

Year 1-2 Life Events=5%

Year 1-2 Transfers=10%

Year 2 Retention=60%

Year 4 Graduation=10%

Year 5 Graduation=20%

Year 6 Graduation=5%

Late Dropout Rate=5%

Then the processor could be configured to calculate graduation rates as follows:

Year 4 Graduation Rate for Transfers=(25%/75%)*(80%/20%)*10%=13.3%

Year 5 Graduation Rate for Transfers=(25%/75%)*(80%/20%)*20%=26.7%

Year 6 Graduation Rate for Transfers=(25%/75%)*(80%/20%)*5%=6.7%

Year 4 Overall Graduation Rate=90%*10%+10%*13.3%=10.3%

Year 5 Overall Graduation Rate=90%*20%+10%*26.7%=20.7%

Year 6 Overall Graduation Rate=90%*5%+10%*6.7%=5.2%

The calculation of enrollment percentages would then be as follows:

Year 1 Enrollment=100.0%

Year 2 Enrollment=(100%−5%)*60%+10%=67.0%

Year 4 Enrollment=(10.3%+20.7%+5.2%)*105%=38.0%

Year 5 Enrollment=(20.7%+5.2%)*105%=27.1%

Year 6 Enrollment=5.2%*105%=5.4%

Year 3 Enrollment=(67.0%*38.0%)̂(½)=50.4%

The calculation of enrollment counts would then be as follows:

Year 1 Enrollment=1,000*100.0%=1,000

Year 2 Enrollment=1,000 *67.0%=670

Year 3 Enrollment=1,000 *50.4%=504

Year 4 Enrollment=1,000 *38.0%=380

Year 5 Enrollment=1,000 *27.1%=271

Year 6 Enrollment=1,000 *5.4%=54

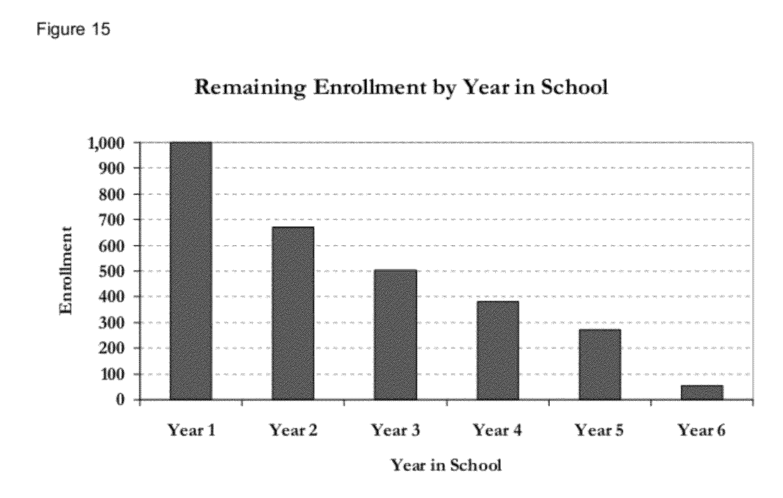

This result is illustrated in FIG. 15. In this example, the estimated enrollment summed across years is greater than the reported total enrollment. This is reasonable because this particular college might have more students transfer out than transfer in, or there may be enrollment growth across cohorts.

Enrollment and Graduation—Two-Year Colleges

Enrollment and graduation data for four-year colleges can be used, in some embodiments, to estimate full-time enrollment by year in college, by institution, using publicly available information. Because there may be only detailed public information on overall and first-year, full-time undergraduate enrollment, information on retention in the second year of college, transfer rates, life-event dropout rates, graduation rates, and enrollment trends can be used to extrapolate enrollment figures beyond the first year.

As a non-limiting example, data can be sourced or derived from the National Center for Education Statistics' (NCES) Integrated Postsecondary Education Data System (IPEDS), which requires Title IV institutions (e.g., institutions providing Stafford loans, Pell Grants, and other sources of federal financial aid) to provide annual institutional and student information, and other NCES studies.

Various types of data may be known, including, for example, overall undergraduate enrollment for multiple colleges; enrollment in year 1 for multiple colleges; transfer and life-event dropout rates after year 1 and overall for multiple colleges; retention in year 2 for non-transfer, non-life-event dropout students for multiple colleges; graduation rate by year 3 for non-transfer, non-life-event dropout students for multiple colleges; and/or degrees awarded for multiple colleges; overall transfer frequency of college graduates for a sample of students.

Some types of data may not be known, including, for example, graduation rates in years 2 and 3 for multiple students; student enrollment in years 2 and 3.

The example methods described herein can be configured to estimate the number of full-time students from any given entry cohort (e.g., Year 1 enrollees) who continue their enrollment in Associate's or Certificate programs in Years 2 and 3, regardless of whether they continue their education at the same institution or not, and how many graduate in Years 2 and 3. This could also be applied to part-time students.

This method utilizes the detailed information on full-time students at the beginning and end of their college careers to interpolate enrollment in the intervening years. This can be done in two steps: 1. Calculate the percentage of students remaining from Year 1 in Years 2 and 3. 2. Apply these percentages to overall enrollment to generate total student counts.

For example, the enrollment percentage in Year 1 can be fixed at 100% by definition. For the full-time enrollment percentage in Year 2, colleges report the percentage of students who transfer or are no longer enrolled as a result of a life event (e.g., death, military service) during or immediately after Year 1, and the Year 2 student retention rate for some or all remaining students. For the full-time enrollment percentages in Year 3, this method takes advantage of the fact that the vast majority of students who do not complete their degree programs drop out in the first half of these programs. Thus, the full-time enrollment percentage in Year 3 should closely match the graduation rate in Year 3. Full-time enrollment beyond Year 4 may be less relevant because of the scarcity of Associate's and Certificate programs that can take more than three years to complete with full-time enrollment.

Institutions may report the graduation rate for non-transfer, non-life-event-dropout students within 3 years. The processor can be configured to separate those who graduate within two years from those who graduate within 3 years. For example, this can be accomplished using at least two possible methods:

1. Course Load. The standard Associate's program requires the completion of 60 standardized course units. The average course load for full-time students, as reported, is 13 standardized course units per semester, or 26 units per year. Thus, the average time to completion is 60/26=2.31 years. Generally, 69% of full-time students who graduate within 3 years may graduate in 2 years, and 31% may graduate in 3 years. The processor can be configured to apply any of these percentages to multiple colleges.

2. Observed Degrees Awarded. Because IPEDS includes both entering classes and degrees awarded in multiple years, the processor can be configured to use simultaneous equations that cover multiple years to determine the ratio of degrees awarded in Years 2 and 3. For example, the number of degrees awarded in any given year can equal the number of students who entered college one year earlier times the proportion who graduate within two years+the number of students who entered college two years earlier times the proportion who graduate within three years. The fact that some students may take longer than three years to graduate is a third-order issue because they can scale up or down the overall graduation rates. This yields the following system of equations:

$$\begin{matrix}… \\ {\hat{M}}^{3 -} {D}_{Y} = {E}_{Y - 1} \times {G}_{Y} \times {\hat{Q}}^{2} + {E}_{Y - 2} \times {G}_{Y} \times {\hat{Q}}^{3} \\ {\hat{M}}^{3 -} {D}_{Y - 1} = {E}_{Y - 2} \times {G}_{Y - 1} \times {\hat{Q}}^{2} + {E}_{Y - 3} \times {G}_{Y - 1} \times {\hat{Q}}^{3} \\ {\hat{M}}^{3 -} {D}_{Y - 2} = {E}_{Y - 3} \times {G}_{Y - 2} \times {\hat{Q}}^{2} + {E}_{Y - 4} \times {G}_{Y - 2} \times {\hat{Q}}^{3} \\ …\end{matrix}$$

where
   D_{y}=degrees awarded in year y,
   M³⁻=general proportion of degrees awarded to students within 3 years (vs. 4+ years)
   E_{y}=Year 1 enrollment—exclusions—transfer students in year y,
   G_{y}=overall graduation rate for the group graduating in year y,
   Qⁱ=proportion of graduates graduating in their i^{th} year, and Q²+Q³=1,
   ̂=designates unknown values

This yields a system of equations with two unknowns (M and Q² because Q³ is 1−Q²). Thus, the processor can be configured to determine Q² and Q³ by observing reported entry and graduation across two IPEDS survey years. The processor can also be configured to add trend factors to M and P₂, and the trend factors could include another year of observation to be analyzed. For example, if the processor is configured to add a trend factor to Q² (and therefore Q³) so that Q² becomes Q², Q²+R, Q²+2R, Q²+3R, and so on as cohorts are spanned, then this new unknown trend variable “R” would indicate the examination of one further equation. The processor can also be configured to add stability to the estimates by taking the average of the estimates across different starting cohorts. For example, the processor could use 2005 and 2006 for estimate 1, 2003 and 2004 for estimate 2, and 2001 and 2002 for estimate 3, and then average the three estimates to yield the desired result.

Because the graduation rates for Years 2 and 3 exclude transfer students, they may be adjusted by these transfer students to accurately reflect their true respective measures. This can be accomplished by the processor using the same or similar methods used for Bachelor's programs as described herein. The enrollment percentage for Year 3 can then be the graduation rate for Year 3, plus a late drop-out factor.

For enrollment in Year 1, IPEDS requires colleges to provide full-time student enrollment in Year 1, and this can serve as an anchor for the rest of the calculations. For enrollment counts in Years 2 and 3, the processor can be configured to apply the enrollment percentages in those years to the Year 1 enrollment. This may not sum to the total enrollment count of the college because this overall count is a snapshot that captures students in different years from different cohorts, and it may also include students who have oscillated between full- and part-time statuses. For example, if enrollment is increasing from year to year, then total enrollment would be less than the figure calculated under this method because it would reflect older cohorts that had smaller entering classes.

The processor can also be configured to use this method to estimate the number of students in the year in college for any given year. To do so, the processor can be configured to adjust to changing enrollment, as described herein with respect to four-year colleges.

Some colleges only report partial information, such as overall graduation only. In those situations, the processor can be configured to use (1) Year 1 or overall full-time enrollment and (2) overall graduation. If the processor is configured with this information, then the other information necessary for calculating the enrollment figures can be created using the general patterns for missing data for institutions of the same type, as designated by Carnegie Classification, location, sector, and other institutional factors. For example, to use the system of equations to determine the ratio of Year 2 to Year 3 graduates in general without having data for one college, the calculation could still be completed. If the ratio was 4:1 for institutions of that college's type, but the college's overall graduation rate was 10%, then the processor could be configured to calculate Year 2 and 3 rates as 8% and 2%, respectively.

In some embodiments, the processor can be configured to use these derived enrollment and graduation rates by year in college in actuarial models to determine the actuarially fair fees when the likelihood and timing of enrollment and graduation are used. In some embodiments, these derived rates can also be used by the financial model to characterize the potential customer base.

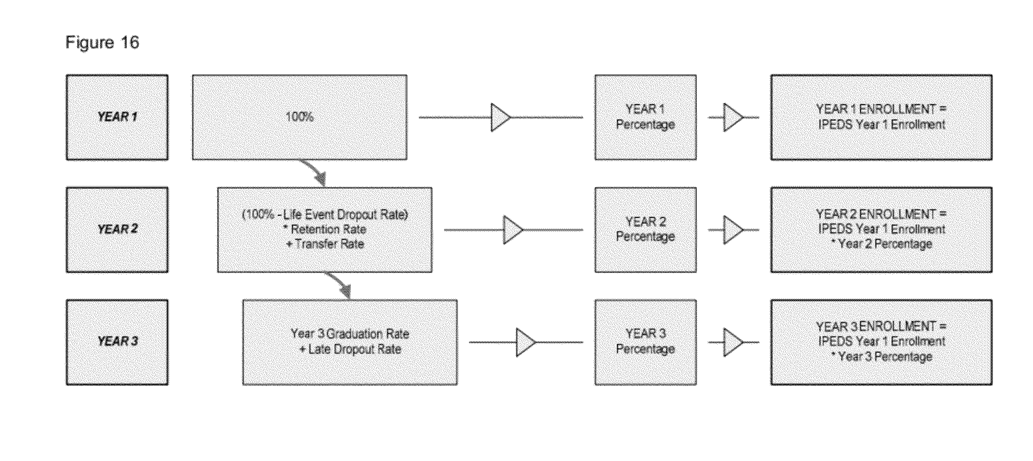

An example embodiment of this method is summarized in the flow chart in FIG. 16. Example data calculations are presented below.

Suppose a college has the following reported information:

Overall Enrollment=1,500

Year 1 Enrollment=1,000

Year 1-2 Life Events=5%

Year 1-2 Transfers=10%

Year 2 Retention=60%

Overall Graduation=20%

Late Dropout Rate=5%

The processor could be configured to calculate graduation rates as follows:

Year 2 Overall Graduation Rate=20%*69%=13.8%

Year 3 Overall Graduation Rate=20%*31%=6.2%

The calculation of enrollment percentages would then be as follows:

Year 1 Enrollment=100.0%

Year 2 Enrollment=(100%−5%)*60%+10%=67.0%

Year 3 Enrollment=6.2%*105%=6.5%

The calculation of enrollment counts would then be as follows:

Year 1 Enrollment=1,000 *100.0%=1,000

Year 2 Enrollment=1,000 *67.0%=670

Year 3 Enrollment=1,000 *6.5%=65

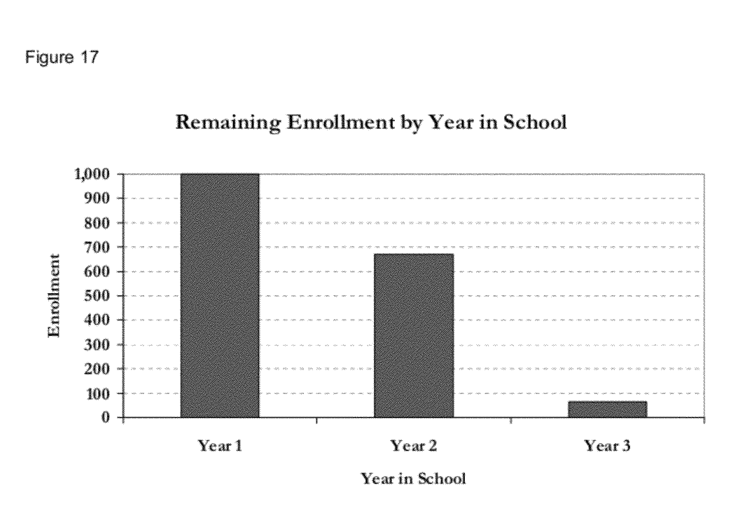

This result is illustrated in FIG. 17. In this example, the estimated enrollment summed across years is greater than the reported total enrollment. This is reasonable because this particular college might have more students transfer out than transfer in, or there may be enrollment growth across cohorts.

Prototype Loan Non-Repayment Patterns

Prototype loan non-repayment patterns can be used, in some embodiments, to estimate the general patterns of loan non-repayment after college graduation using publicly available information. While the available public information on loan non-repayment may only provide snapshots of loan non-repayment across some or all existing graduation cohorts, these snapshots can include both the overall non-repayment levels and the duration of non-repayment for those in delinquency at the time. As a result, in some embodiments, the processor can be configured to utilize the mathematical relationship that exists between the snapshots of loan non-repayment at any given time and the patterns of loan non-repayment for cohorts. For example, the processor can be configured to extrapolate the non-repayment patterns for a cohort of graduates by assuming that the underlying patterns of non-repayment keep the same or similar general shape across cohorts and simulating what a cohort's pattern can look like to generate the snapshots that have been observed. This method can reflect underlying, long-term averages which can be indicative of various economic situations. As such, the processor can be configured to adjust it by economic circumstances before it is applied to a given year.

As non-limiting examples, data can be sourced or derived from the Department of Education, Fitch Ratings, and other reports on loan non-repayment.

Various types of data may be known, including, for example, overall default, deferment, and forbearance, over time; delinquency in specific cases, such as for specific lenders; and/or the duration of delinquency (e.g., 30-60 days, 60-90 days) overall and for specific states.

Various types of data may be known, including, for example, the timing of delinquency, default, deferment, and forbearance for a given cohort; the level of delinquency, default, deferment, and forbearance for a given cohort; and/or the duration of delinquency, default, deferment, and forbearance for a given cohort.

Types of Loan Non-Repayment

Loan non-repayment can take different forms. For example: delinquency of 270 days or less (hereafter referred to as “delinquency”), delinquency of 271 days or more (hereafter referred to as “default”), deferment, and forbearance. These examples are further explained below.

1. Delinquency. Unapproved non-repayment of loans for 270 days or less. Interest may be capitalized.

2. Default. Unapproved non-repayment of loans for 271 days or longer. Debt-recovery actions may be triggered.

3. Deferment. Lender-approved, moderate-to-long-period cessation of loan repayments. Commonly offered when a graduate has reenrolled in a college, fellowship, or rehabilitation program or when a graduate experiences certain types of unemployment or other forms of economic hardship. Interest does not capitalize for subsidized Stafford loans when a graduate is in deferment in many cases but does capitalize for unsubsidized Stafford loans.

4. Forbearance. Lender-approved, short-period reduction in or cessation of loan repayments. Commonly offered when a graduate does not qualify for full deferment. Interest capitalizes when a graduate is in forbearance.

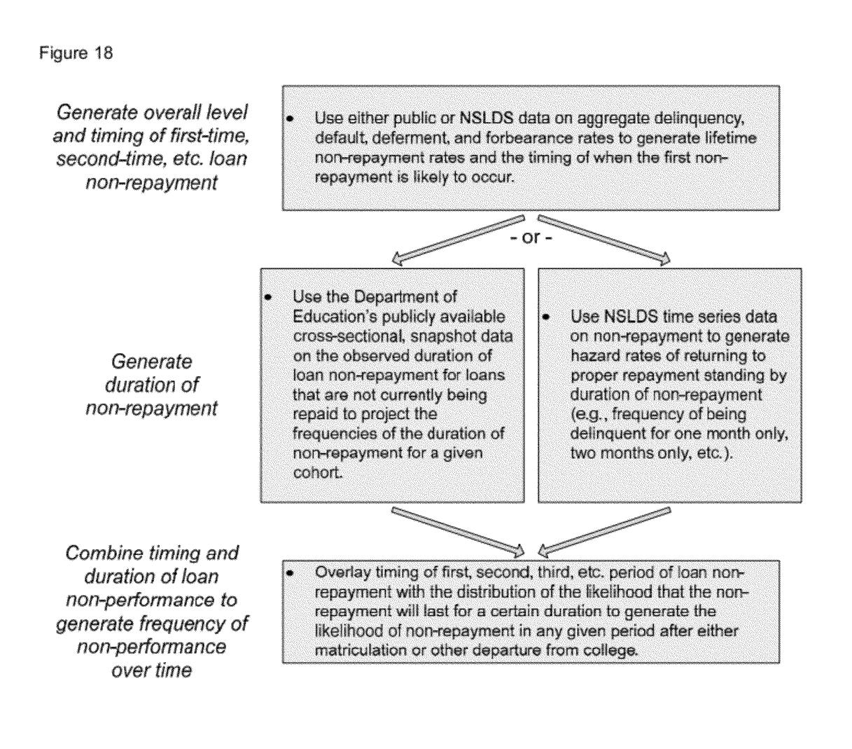

The example methods described herein can be used to generate the likelihood of loan non-repayment at a point in time for a given cohort. An example method is described in FIG. 18.

Delinquency and Default

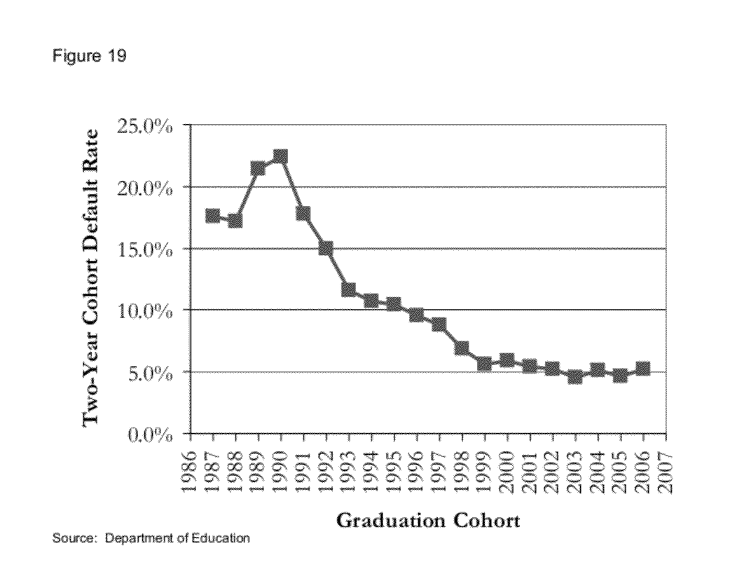

With respect to default, the Department of Education has traditionally published two-year cohort default rates and may also publish cumulative default rates for specific cohorts and overall. An example of this data is presented in FIG. 19.

Because the two-year cohort default rates reflect those who have been delinquent for 271 days, or 9 months, it captures those who began delinquency behavior within (24−9)=15 months after entering their repayment period. With respect to 2006 graduation cohort data (e.g., their last year in college was the 2005-06 academic year), the Department's data show that the two-year cohort default rate has stabilized around 5% over the past 5 most recent cohorts. This rate was expected to increase as a result of the 2008-09 economic recession, but this fact can be less relevant for developing the prototype because it is designed to model the underlying system, and it can be adjusted based upon the economic climate by another part of the overall model. Thus, 5% of student loans were first in delinquency within 15 months of students entering repayment and continued to be in delinquency for 9 months or more.

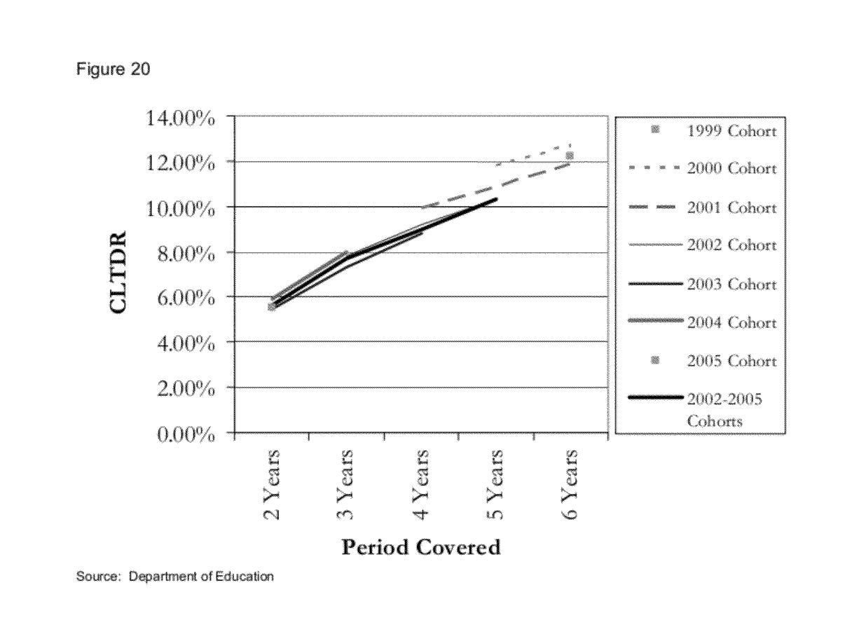

The Department of Education's cumulative lifetime default rates (CLTDR) are a loan performance management tool similar to the cohort default rates, but they cover cohorts for a longer period of time. While this measure may not exist for an extensive period for any cohort, it does show the stability of the default pattern over the period of repayment. It also is based on the fiscal year, and therefore covers additional months and reports default rates at the two-year mark that are higher than the traditional cohort default rates. Using the naming convention of the CLTDR, the average 2^{nd} through 5^{th} year default rates are 5.6%, 7.1%, 9.0%, and 10.3%, respectively, showing a consistent attenuation as loans go further into their repayment period. This data is illustrated in FIG. 20.

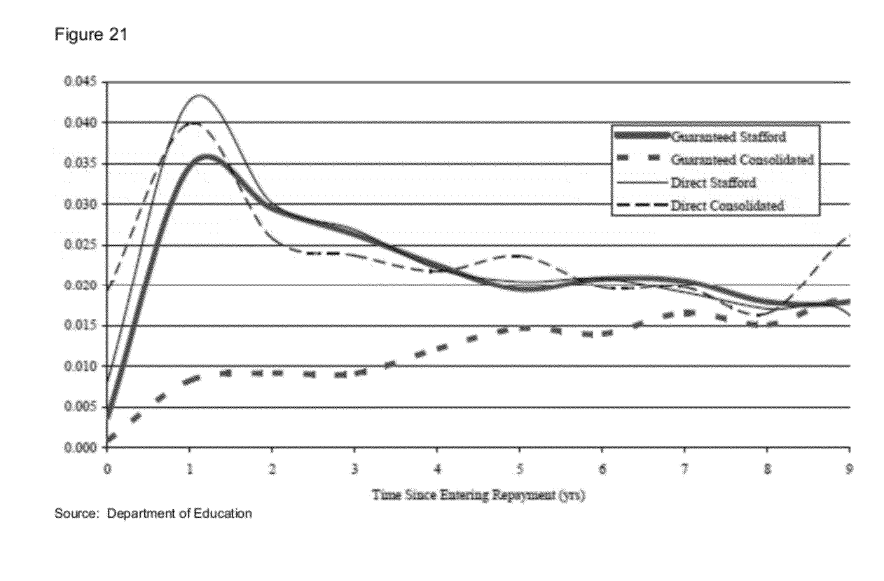

The processor can be configured to extrapolate these rates before and after the covered years of the CLTDR. The Department provides information on default timing that is both suitable for this purpose and for determining the timing of default in and of itself. In some embodiments, the annualized default rates for loans by the number of years since entering repayment for all loans in repayment in a given year can be used. The Department's data show that the rates are almost identical, regardless of whether loans are provided through the Direct Stafford Loan Program or through the Guaranteed Stafford Loan Program. Ignoring consolidation loans, these data show that 2^{nd} through 5^{th} year cumulative default rates to be 4.6%, 7.5%, 10.0%, and 12.1%, respectively, consistent with the two other measures. This data is illustrated in FIG. 21.

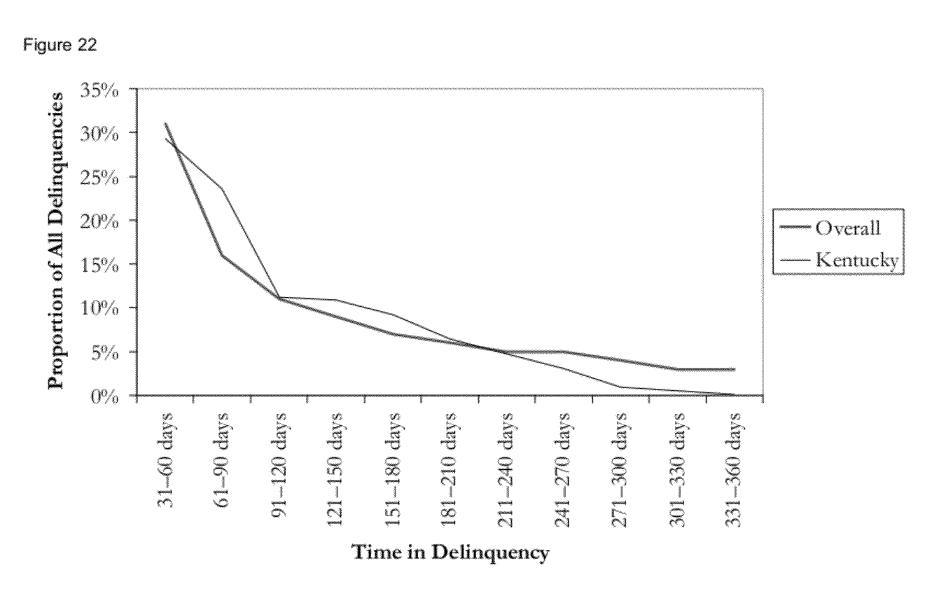

As a result of the consistent patterns between the measures, the processor can be configured to use the default timing figures to extrapolate to one or more quarters after graduation. An example of this extrapolation is illustrated in FIG. 22 which plots delinquency over time periods for an overall national pattern as well as for a specific state pattern. These types of patterns can be used to calculate the likelihood that a borrower who is one month delinquent will also be delinquent again the following month, as well as the likelihood that a month 2 delinquency leads to a month 3 delinquency, and so on. For example, the processor can be configured to estimate the proportion of month 2 delinquencies that become month 3 delinquencies by dividing the proportion in month 3 by the proportion in month 2, thereby generating a month-by-month hazard rate of continuing delinquency.

To extrapolate beyond the 9^{th} year, this measure may become problematic to the extent it reflects cohorts that entered repayment in the 1990s when cohort default rates in general were high. Thus, using this measure beyond the 5^{th} year could yield an over count of overall default for current cohorts. Instead, the processor can be configured to use the generally linear downward trend in incremental default from years 2 through 5 to extrapolate to years 6 and beyond. This is reflected in the following equation:

D^{I}=2.0%−S×(I−5)
where
   Dⁱ=frequency of default at time i after entering repayment,
   2.0%=the observed default rate at the 5 year mark,
   S=slope of the default frequency between 2 and 5 years after graduation

Using this method, defaults effectively go to zero at the 10 year mark, which is the standard repayment period. This also results in a lifetime default rate of 16.8%. Thus, the processor can be configured to calculate both the timing and level of default over the entire repayment period.

For delinquency, because it is similar to default, the processor can be configured to use the timing of default as the primary indicator for the timing of the delinquency. For the level of lifetime delinquency, the processor can be configured to use the relatively stable Department of Education reports of 30% and 32% lifetime delinquency or double the lifetime default rate. Alternatively, the processor can be configured use the snapshot of the delinquency duration as the basis of comparing the level of delinquency with the level of default. As a non-limiting example, the processor can be configured to compare the ratio of delinquencies that have lasted for 270 days or less to delinquencies that have lasted for 271 days or more.

The proportion of delinquencies reported by education may cover only the first 360 days, so taking the ratio of delinquencies of 270 days or less to delinquencies of 271 to 360 days can undercount defaults and therefore over count delinquencies. To correct for this, the processor can be configured to extrapolate the proportion of delinquencies lasting 361 days or longer from the reported information. Because the reported data clearly follow an asymptotic pattern, the processor can be configured to maximize the fit of a hyperbolic (or similar) equation to make this extrapolation:

$${\hat{D}}_{M} = α + \frac{β}{δ + M} + ɛ$$

where
   Dₘ=frequency of delinquency at month m after entering repayment,
   α, β, δ=parameters to be estimated,
   ε=error term

Based on the data reported by the Department of Education, a fit for this line can be as follows:

$${\hat{D}}_{M} = 0.27 \% + \frac{33.80 \%}{10.21 \% + M}$$

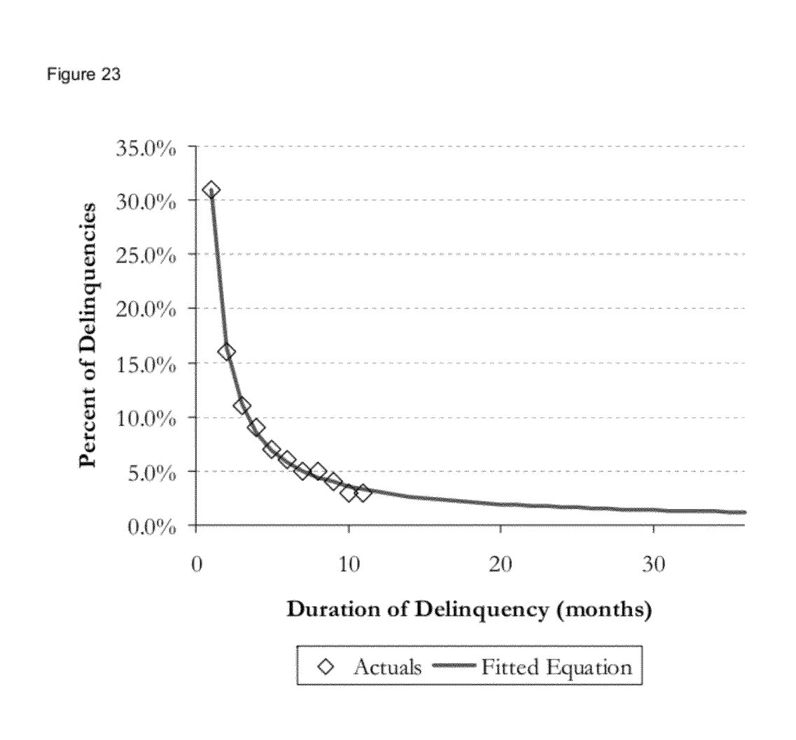

This fit is illustrated in FIG. 23.

Thus, for example, for delinquencies from 31-60 days, D=0.27%+33.80%/(10.21%+1)=30.93%. The sum of the delinquencies may be over or under 100%, which is acceptable because the original measure looks at the first 360 days. In order to obtain a full measure, then, the processor can be configured to scale the overall sum down so that the new sum adds to 100%. In some instances, this can be less relevant to the ratio, however, because this scaling factor can cancel out.

To calculate what happens during the first 5 years of repayment, the processor can be configured to sum of the delinquencies lasting 270 days or fewer and divide it by the delinquencies lasting 271 days or longer, up to 5 years to generate the level of overall delinquency in relation to default. In this case, the ratio is 1.12, so the 5-year delinquency rate would be 12.1% (the 5-year default rate)*1.12=13.5%.

To determine the duration of any given delinquency or default, the processor can be configured to use a difference function of the fitted equation above. For example, in a static system in the 2000s, which is supported by the stable default rates of the 2000s, then the difference between the frequency that have been delinquent for period i and the frequency that have been delinquent for period i+1 can be calculated as the proportion of delinquencies that can be in delinquency for period i. For example, if 34.7% of delinquencies lasting 270 days or less at any given time are one month old and 18.3% of these same delinquencies are two months old, then (34.7%−18.3%)=16.4% of delinquencies on average can last for one month. Similarly, if 5.0% of the snapshot of defaults (e.g., delinquencies lasting 271 or more days) started within the past month and 4.5% started two months ago, then 0.5% of defaults can last one month before being rehabilitated. This can also be adjusted for underlying enrollment trends as described herein with respect to enrollment and graduation rates.

This can be summarized in the following equation:

d_{I}=D_{I}−D_{I+1}
where
   dᵢ=likelihood of loan non-repayment lasting i periods,
   Dᵢ=likelihood of loan non-repayment lasting at least i periods

In the case of a fixed period of time I* (e.g., there is a cap on the maximum length), then there is a terminal condition where d_{I*} is equal to D_{I}*.

The processor can be configured to use the Department's National Student Loan Data System (NSLDS), which may include some or all of repayment, delinquency, default, deferment, and forbearance data for multiple periods for multiple loans to generate the likelihood and duration of loan non-repayment directly.

Prototype Loan Non-Repayment Patterns: Deferment and Forbearance

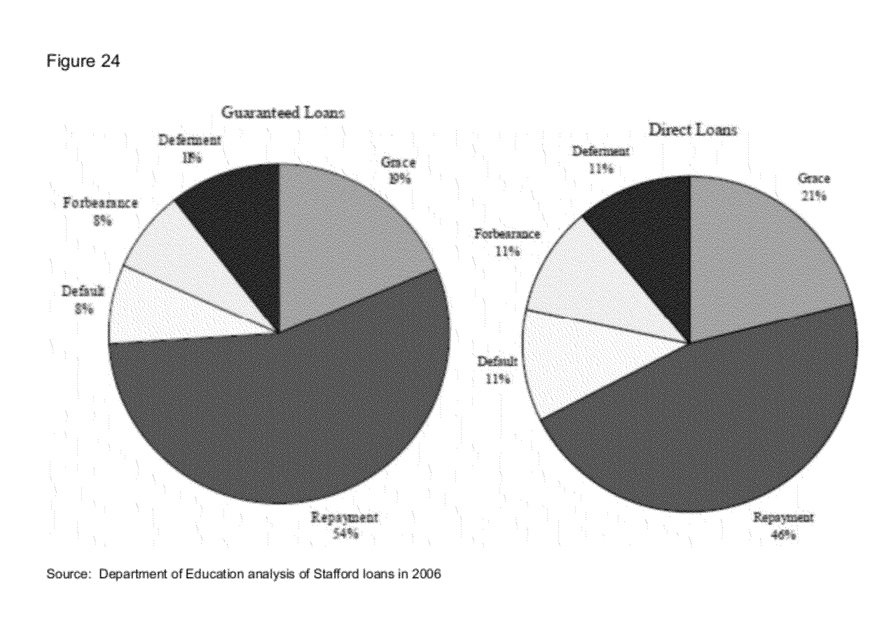

For the overall levels of deferment and forbearance, both Fitch Ratings and the Department of Education have published historical deferment and forbearance rates. Examples of these rates are illustrated in FIG. 24. In some embodiments, Fitch Ratings analysis can be directly applied to federal student loans, or the processor can be can be configured to perform a weighted average of the two types of loans, where loan non-repayment for direct loans is inflated based on the overall observed loan non-repayment rates.

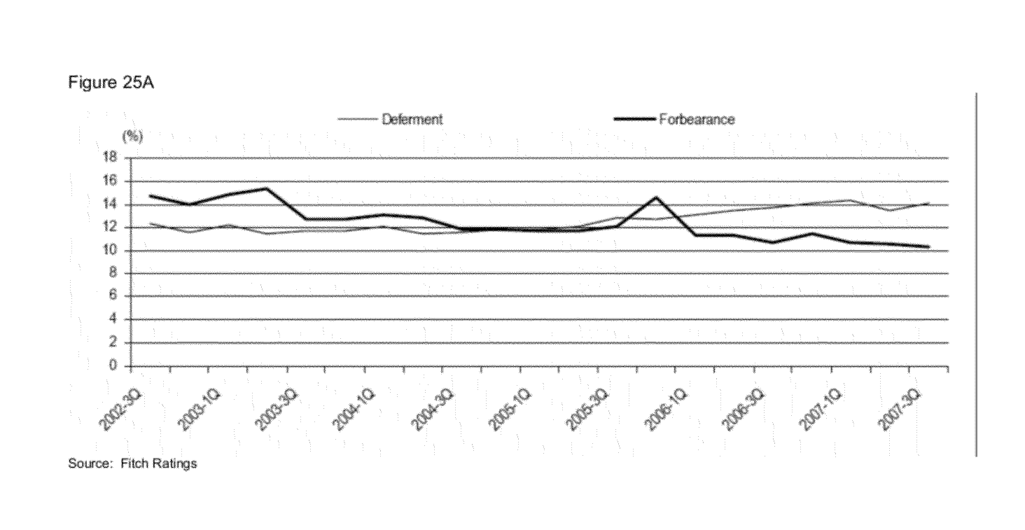

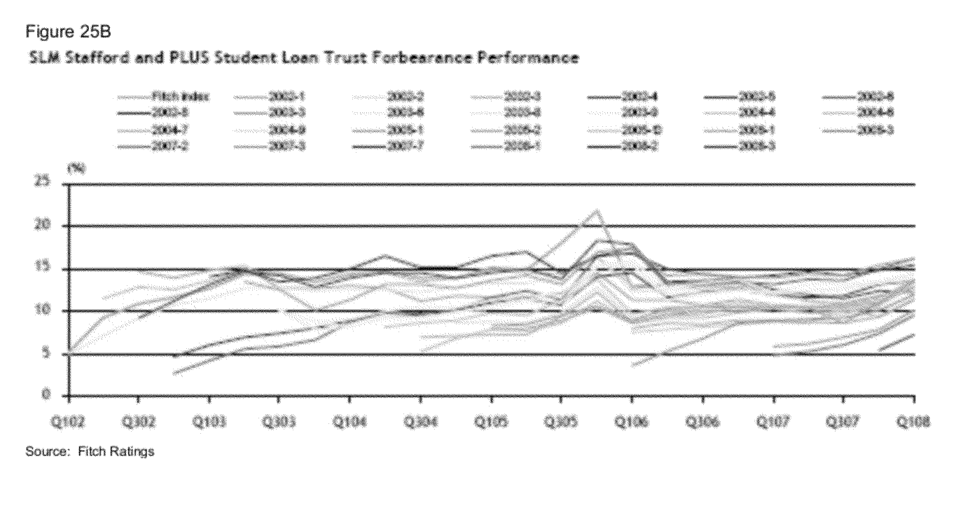

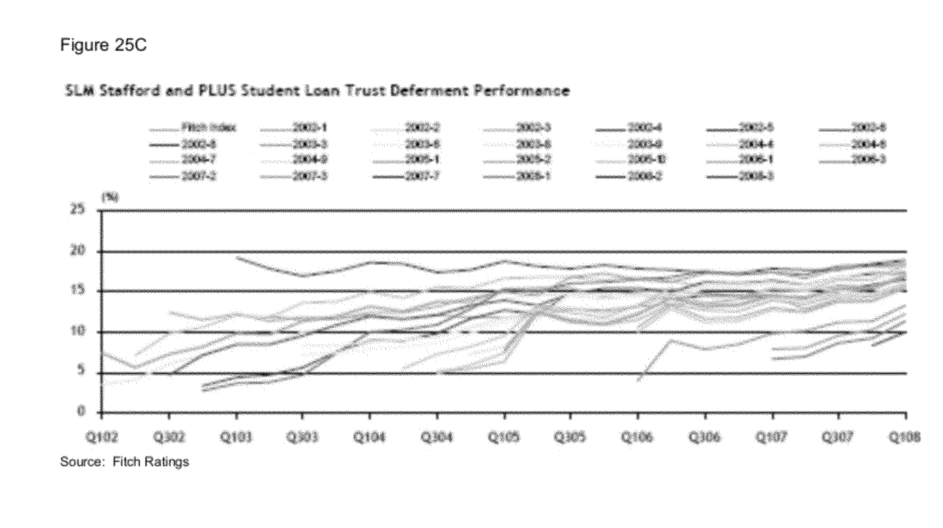

Fitch Ratings may regularly publish deferment and forbearance indexes that reflect the proportion of all outstanding loans that may be in deferment and forbearance in each quarter. Examples of these indexes are illustrated in FIGS. 25A-25C.

The processor can be configured to take as input a snapshot of loans in deferment or forbearance at any given time. The processor can then be configured to adjust the observed rate according to the level, timing, and duration of such deferment and forbearance. For example, if the underlying deferment rate is d, the deferment happens in year one 60% of the time and in year two 40% of the time, deferment lasts for one year 50% of the time and two years 50% of the time, and cohorts are identical or substantially identical in size C, then the observed instantaneous deferment rate D would be as follows:

$$D = \frac{Year 1 Deferment \times C + Year 2 Deferment \times C + Year 3 Deferment \times C}{LoansInTheirPaymentPeriod}$$

$$D = \frac{d \times 60 \% \times C + ( \begin{matrix}d \times 60 \% \times C \times \\ 50 \% + d \times 40 \% \times C\end{matrix} ) + ( d \times 40 \% \times C \times 50 \% )}{10 C + 100 \% \times d \times C + 50 \% \times d \times C}$$

As the cohort size cancels, a deferment rate D=d*1.5/(10+1.5d). Thus, an overall 5% rate at any given time would result in an underlying deferment rate of 35%. This method can be adjusted for changing cohort sizes by iterating the actual cohort sizes Cᵢ for cohorts i.

If the average points of first deferment and default are at 3.9 years and 4.8 years, whereas the average point of first delinquency is at the 3.5 year mark, then deferment may be very similar, but not necessarily identical, to delinquency. In some embodiments, the processor may be configured to assume that that forbearance has the same or similar timing as delinquency. Based on the average point of first forbearance being 4.8 years, this can indicate a more uniform timing of first forbearance across the entire repayment period. Thus, the processor can be configured to make a more accurate estimate by interpolating between the timing for first delinquency and a uniformly distributed timing.

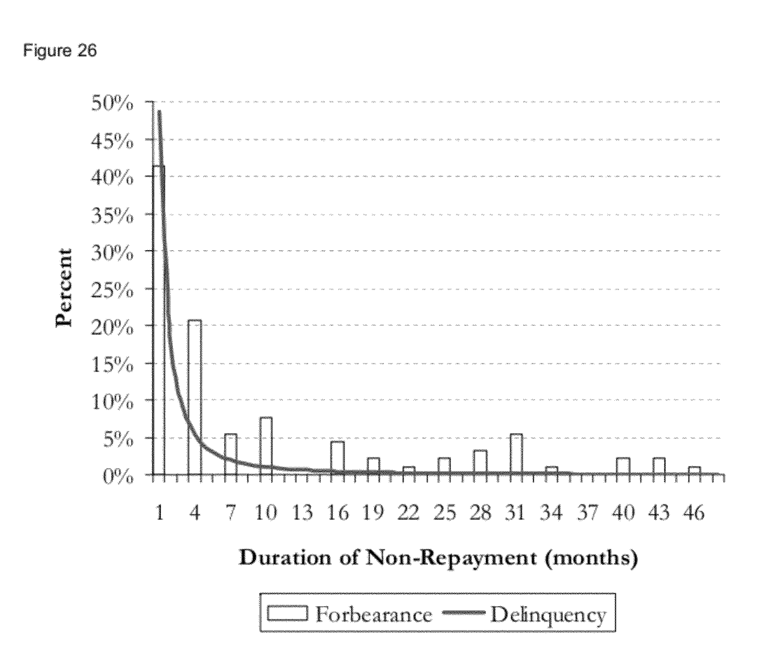

Regarding the duration of deferment and forbearance, the two lender-approved options are typically restricted to be less than 3 years and are commonly for 1 year (at a time). In some embodiments, the processor can be configured to fit a different standardized duration curve to the forbearance data. Deferment, if between delinquency and forbearance, could therefore be an interpolation (e.g., average) between the two curves. Once that is available, the processor can be configured to calculate the difference in frequencies across time periods to determine the frequency of being in deferment or forbearance for that period of time. An example of this analysis is illustrated in FIG. 26.

Loan Non-Repayment by Period

Once information on delinquency, default, deferment, and forbearance is provided to the processor, the processor can then be configured to overlay a type of information on top of another to generate the likelihood of being in a non-repayment status at any given time. For example, the period 1 likelihood can be the sum of the frequencies of starting delinquency, default, deferment, or forbearance in period 1, and the period 2 likelihood can be the sum of the non-repayment frequency for period 1* the likelihood of continuing non-repayment in a second period+the sum of the frequencies of starting delinquency, default, deferment, or forbearance in period 2. This can be explained by the following equation:

NR_{I}=Pr(FNR_{I})+Pr(FNR_{I-1})×L²+Pr(FNR_{I-2})×L³+ . . .
where
   NRᵢ=frequency of first and continued delinquency, default, deferment, or forbearance at period i after entering repayment,
   PR(♦)=probability of event ♦,
   FNRᵢ=first non-repayment at period i,
   L^{t}=probability that non-repayment may last t periods

In some embodiments, the results of this module can be used directly as a national estimate of average loan non-repayment rates, and/or also be adjusted by the prototype modification module to determine the fees under projected economic circumstances and to determine the fees for multiple college institutions.

Prototype Modifications: Economic Conditions and Individual Colleges

Economic conditions data can be used, in some embodiments, to adjust the patterns of loan non-repayment based on economic conditions and to apply the resultant patterns to specific college institutions using publicly available information. If the prototype of loan non-repayment is based on the stable patterns of the early 2000s, in some instances, it can be less applicable to changing economic circumstances. However, the model can be adjusted by examining past loan non-repayment behavior in relation to past unemployment rates and other economic indicators and applying the results of this analysis to the original, prototype non-repayment patterns. Furthermore, for individual institutions, this method can utilize the two-year cohort default rates published for multiple institutions as an anchor, or scaling factor, that can be applied to the prototype pattern to tailor the non-repayment patterns to multiple institution's historical non-repayment behavior or related trend.

As non-limiting examples, data can be sourced or derived from loan non-repayment prototype, Department of Education and Fitch ratings student loan reports, and/or Bureau of Labor Statistics unemployment reports.

Various types of data may be known, including, for example, loan non-repayment prototype; historical aggregate loan non-repayment rates; and/or historical unemployment rates.

Some types of data may not be known, including, for example, how loan non-repayment patterns would react to changing economic conditions; and/or loan non-repayment patterns for individual institutions.

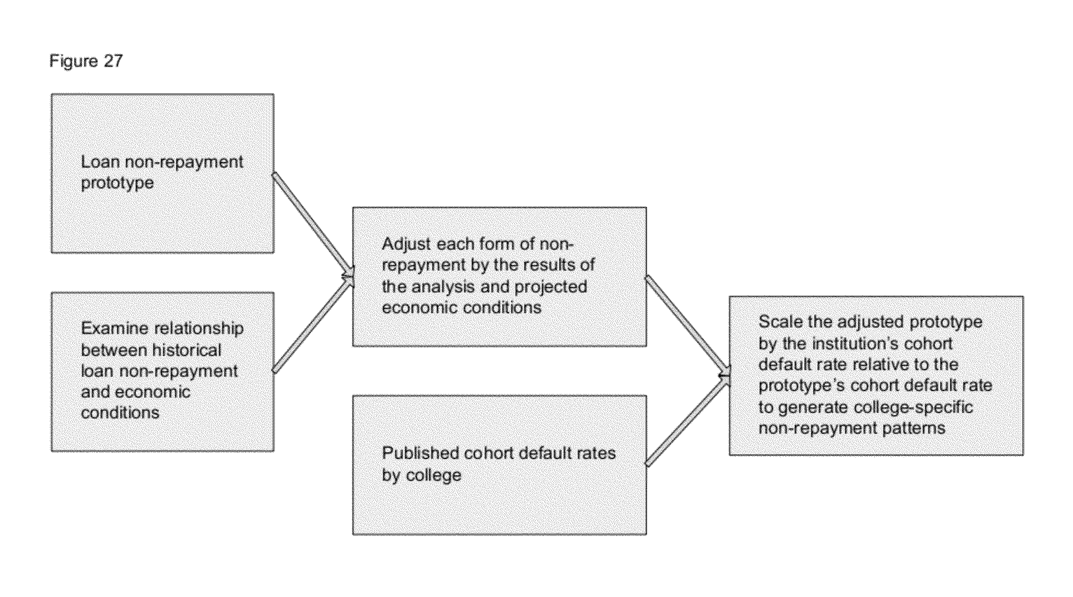

The example methods described herein can be used to make adjustments and are illustrated in the flow chart in FIG. 27.

Projected Economic Circumstances

Data on loan non-repayment rates and economic conditions can be processed to determine any relationships the two types of data might have. Forecasts of future economic conditions can be used to project how changing circumstances might affect future loan repayment patterns. Data on loan non-repayment, as discussed herein, may be provided by the Department of Education and other organizations. Data on economic conditions for the labor market, such as unemployment and labor force participation, may be provided on a monthly basis by the Bureau of Labor Statistics and other government agencies. In some embodiments, the processor can be configured to examine the relationship between these economic conditions and the loan repayment patterns that result. This method can be configured to focus on the repayment of college graduates and/or those who have student loans in general.

As a non-limiting example, this method can be performed by the processor by executing some of all of the following three steps:

1. Examine the relationship between overall unemployment and college graduate unemployment.

2. Examine the relationship between college graduate unemployment and loan non-repayment.

3. Combine these two analyses to derive forecasted loan non-repayment based on projected overall unemployment rates.

In some embodiments, the processor can be configured to examine the relationship general unemployment with unemployment for college graduates using any method known in labor economics. For example, an inverse function with shift can be used:

$${U}_{T}^{G} = α + \frac{β}{δ + {U}_{T}^{O}} + {ɛ}_{T}$$

where
   U^{g}ₜ=unemployment of college graduates at time t,
   U^{o}ₜ=overall unemployment at time t,
   α, β, δ=parameters to be estimated
   εₜ=error term

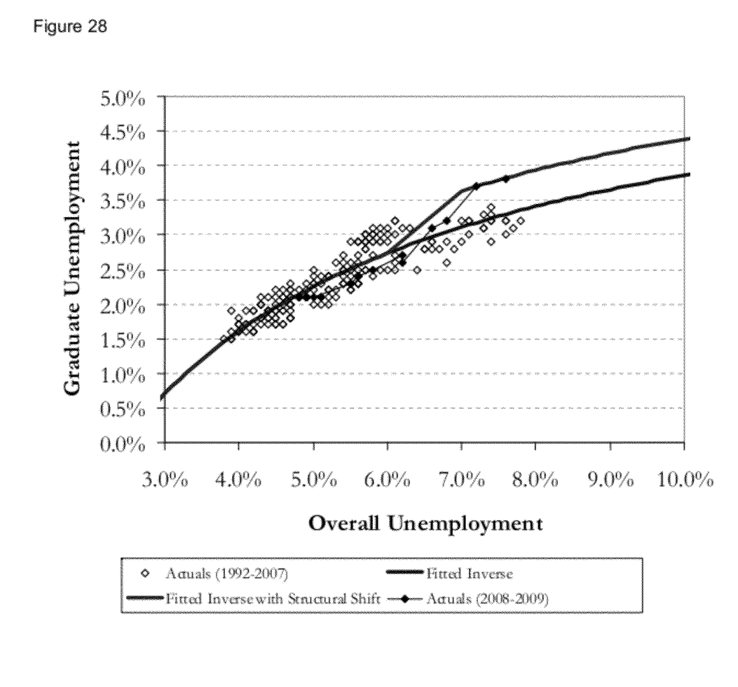

An example plot of this function is illustrated in FIG. 28.

If there is a structural shift in how unemployment affects different subgroups, including college graduates, the processor can be configured to adjust the fitted model to reflect an underlying structural shift.

In other embodiments, to calculate loan repayment patterns for those with student loans in general, the processor could be configured to use age-specific unemployment (or labor force participation or salary) rates. Similarly, to calculate loan repayment patterns for a particular area, the processor could be configured to use unemployment (or other economic factors) by geographic location, as published by the Bureau.

Once the economic factors have been identified, the processor can then be configured to examine their direct relationship to loan non-repayment rates. As with the relationship between overall and college graduate unemployment, these can take many forms and can be designed according to validated relationships. The processor can be configured to select which class of relationships based on standard statistical tests, such as R² tests, F tests, and similar tests. The general forms of these equations may be as follows, using unemployment as a sample economic factor:

Delinquency_{T}=f(U_{T}^{G})+ε_{T}

Default_{T}=g(U_{T}^{G})+φ_{T}

Deferment_{T}=h(U_{T}^{G})+γ_{T}

Forbearance_{T}=i(U_{T}^{G})+π^{T}
where
   f(♦),g(♦), h(♦), i(♦)=general functional forms,
   U^{G}ₜ=college graduate unemployment at time t,
   εₜ, ψₜ, γₜ, πₜ=error terms

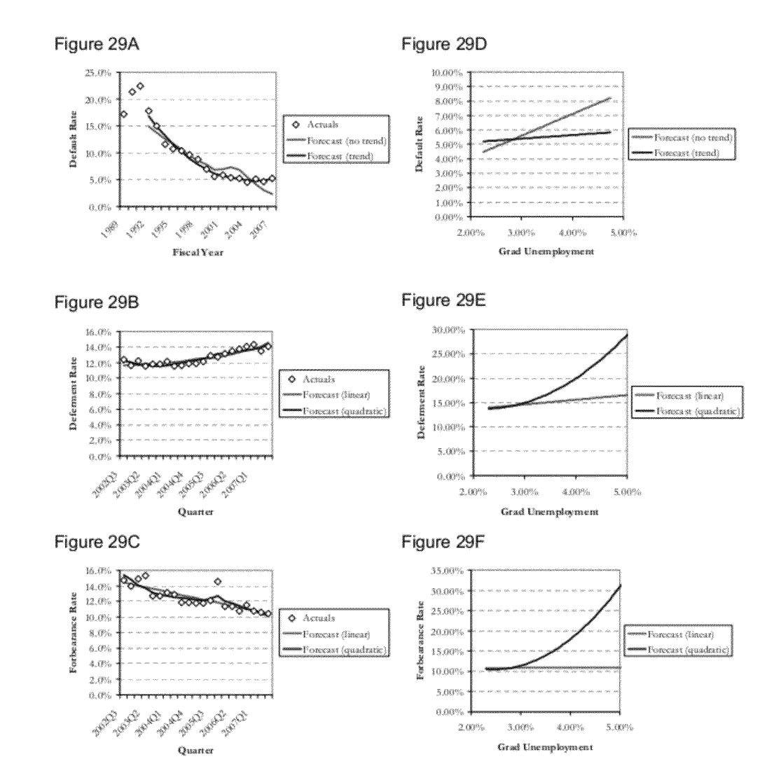

Example results of these regressions (historical vs. projected based on potential forecasted conditions) are illustrated in FIGS. 29A-29F.

Optionally, the processor can be configured to derive forecasted non-repayment patterns by nesting these two analyses:

NR_{J}=f(U_{J}^{G})+ε_{J}

NR_{J}=f[g(U_{J}^{O})]+ε_{J}
where
   NRᵢ=non-repayment rate at forecast j,
   f(♦), g(♦)=general functional forms,
   U^{G}ⱼ=college graduate unemployment at forecast j,
   U^{O}ⱼ=overall unemployment at forecast j,
   εⱼ=error term

Once the two analyses have been completed, because these are systematic relationships, there may be a mathematical correspondence with running a modified regression of general unemployment on loan non-repayment.

In some embodiments, this analysis may yield a lookup table, and any projected level of overall unemployment can be selected to determine what the expected college graduate unemployment rate would be. Based on this information, the processor can be configured to determine a forecasted loan non-repayment levels.

Commonly, historical data on the different types of loan non-repayment are for specific aspects of those non-repayments. For example, the most extensive data on defaults may be on the two-year cohort default rate. In some embodiments, an analysis of default may be based on the relationship between college graduate unemployment and this point-in-time default rate. In some embodiments, this relationship can be used as an anchor for the entire pattern of non-repayment. For example, unemployment is expected to double and therefore college graduate unemployment to increase by 50%, and the two-year cohort default rate to increase by 60%, then default can be scaled at any point after entering the repayment period by 1.6. Thus, default rates would increase by 60%. This may be similar to how the prototype non-repayment patterns are adjusted for specific college institutions, as discussed below.

In other embodiments, the processor may be configured to execute some or all of the following steps in connection with, for example, default rates:

1. Adjust default differentially by the point in repayment. For example, the processor could systematically increase the one year default rate by more than 60% and the three year default rate by less than 60%. In some embodiments, if the step yields an increase of 60% at the two year mark, it would be a valid scaling.

2. Adjust economic factors differentially over time. For example, it may be expected unemployment will be double that of historical levels when a cohort first graduates but then have unemployment return to historical levels after 5 years (in the middle of the standard loan repayment period). Then, for multiple points in repayment, there may be a different underlying default curve that is specified by the value of the economic factor at that point in the repayment period.

Executing these steps, the processor may calculate forecasted loan non-repayment patterns that are adjusted for projected economic conditions.

Non-Repayment Patterns by College Institution

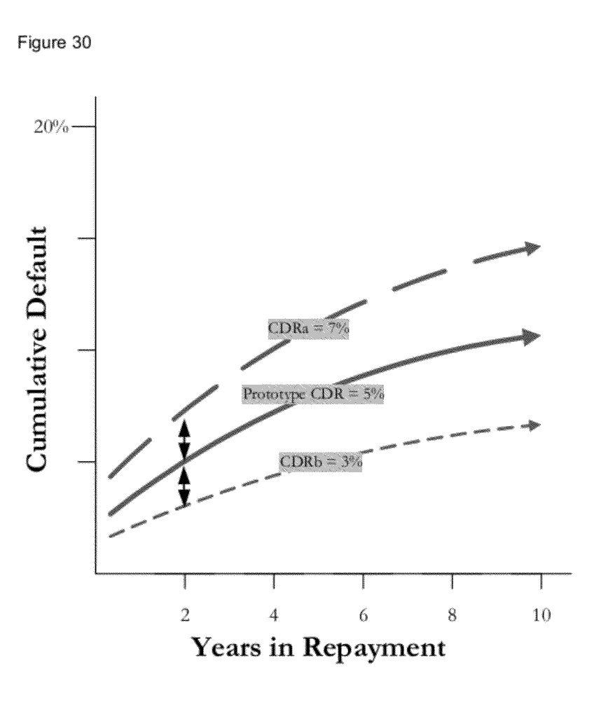

To apply patterns to specific institutions, the processor can be configured to use the published two two-year cohort default rates for college institutions participating in Title IV programs (e.g., Pell Grants) as anchors. For example, the prototype default pattern, adjusted for economic conditions, can be scaled proportionately up or down at the two-year mark so that it results in a two-year cohort default rate that is equal to or substantially equal to the institution's published cohort default rate. For example, if institution a has a published default rate of 7%, but the prototype has a default rate of 5%, then the point of the default curve could be scaled up by 7%/5% to yield the institution's cumulative cohort default curve. Similarly, if institution b has a default rate of 3%, then the scaling factor would be 3%/5%. An example of these calculations is illustrated in FIG. 30.

Alternatively, the processor could be configured to scale up using different functions (e.g., 7%−5%=2%), including proportionate or disproportionate scaling:

$${CDR}_{T}^{S} = {CDR}_{T}^{P} \times ScalingFactor = {CDR}_{T}^{P} \times \frac{{CDR}_{2}^{S}}{{CDR}_{2}^{P}}$$

where
   CDR^{s}ₜ=cumulative cohort default rate for school s at t years into repayment,
   CDR^{p}ₜ=cumulative cohort default rate for the prototype at t years into repayment

The processor can be configured to then scale the other forms of loan non-repayment by the same or similar factor that the default is scaled, assuming similar behavior across the other three forms of non-repayment. The processor can be configured to adjust this based on further analysis of differential patterns of delinquency, deferment, and forbearance relative to default if desired (e.g., the processor may calculate that forbearance increases more than default at high default schools). Also, if the cohort default rate (CDR) is not published for a particular college, then the processor could instead use the average CDR for colleges of a similar type or in a similar location.

A further remaining correction can be used by the processor to examine college graduates (or non-graduates). The Department of Education has published historical delinquency rates of college graduates and non-graduates that show that non-graduates overall are 25/8≈3 times more likely to be delinquent than graduates. Because the Department also publishes annual graduation rates for each Title IV institution, the processor can be configured to calculate what the default rates—and by extension the other forms of loan non-repayment—can be used to generate the overall observed two-year cohort default rate:

$${CDR}_{2}^{G} = {CDR}_{2}^{O} \times \frac{1}{G + \frac{25}{8} \times ( 1 - G )}$$

$${CDR}_{2}^{NG} = {CDR}_{2}^{G} \times \frac{25}{8}$$

where
   CDR^{G}₂=two-year cohort default rate for college graduates,
   CDR^{NG}₂=two-year cohort default rate for non-graduates,
   CDR^{O}₂=two-year cohort default rate for the college as a whole,
   G=graduation rate at the college

If default rates or graduation rates at a particular college are high, this can result in default rates for non-graduates that are arithmetically above 100%, which is impossible, thus the scaling can be used to attenuate as this rate approaches 100%. An example way to correct for this is to limit the spread between graduates and non-graduates to be such that non-graduate default maximizes at 100%:

$${CDR}_{2}^{G} = max ( {CDR}_{2}^{O} \times \frac{1}{G + \frac{25}{8} \times ( 1 - G )} , \frac{{CDR}_{2}^{O} - ( 1 - G )}{G} )$$

$${CDR}_{2}^{NG} = min ( {CDR}_{2}^{G} \times \frac{25}{8} , 100 \% )$$

The processor can also be configured to interpolate between these two models to capture continuous or substantially continuous attenuation.

Once the cohort default rate is determined, the processor can use that calculation in coordination with the prototype cohort default rate to scale up various forms of loan non-repayment, as discussed above. At this point, the processor can calculate the loan repayment patterns tailored for the college institutions overall, for graduates only, and for non-graduates only.

Valuing Loan Non-Repayment

This module's preliminary results are the likelihood of loan non-repayment at multiple points in the student loan repayment period. To determine the actuarially fair fees by cohort and by college, the processor can be configured to determine the value, in present dollar terms, of these missed loan repayments.

The first step of this valuation is to calculate the net present value of these missed payments for students who graduate. If not discounting these missed repayments, the processor can perform this can be done by summing the product of the expected percentage of loan non-repayments in multiple periods of repayment, as determined above, and the average loan payment amount. (This would be an average result by college.) The average loan payment amount can be based on the reported loan amounts at a particular institution or on a standardized loan amount (e.g, $5,000 has been the average annual loan amount in recent years, and these loans can have a 6.0% interest rate for students in the 2009-10 academic year, translating into a monthly payment of about $150), as chosen by the user of this model. If discounting is desired, then this negative cash flow series can be adjusted by the processor based on standard discounting procedures using the preferred discount rate.

To determine what the net present value of the missed loan payments of graduates per student enrolled in any year in school (as opposed to graduates), the processor can be configured to divide this value by the graduation rate from that class because not everyone in the class may graduate:

$${NPV}_{I}^{O} = {NPV}_{I}^{G} \times \frac{{NPV}_{I}^{G}}{{G}_{I}}$$

where
   NPV^{O}ᵢ=net present value of lost cash flows averaged across enrollees in their i^{th} year,
   NPV^{G}ᵢ=net present value of lost cash flows for students who may graduate but are currently in their i^{th} year,
   Gᵢ=graduation rate of students in their i^{th} year

Furthermore, if participation in the SLRP is voluntary, then there would likely be adverse selection in product take up. Thus, the processor could be configured to divide the CDR by this adverse selection factor to determine the CDR for this subset of the population. For example, if the underlying CDR was 25% and it was expected that the 75% of students most likely to miss loan payments would be the ones who purchased this product, then their specific CDR could be calculated as 25%/75%=33.3%. The adjusted CDR may be capped at 100%.

Once this has been determined, the processor can be configured to apply this adjusted CDR to the general loan non-repayment scaling procedure, determine the resultant expected average cash flows, and derive the net present value of those missed loan payments for multiple colleges. This net present value can then serve as the actuarially fair rate for the colleges that can be used in standard financial modeling.

Economic Hardship—By College Institution

Economic hardship can be used, in some embodiments, to estimate wages and unemployment rates by college after graduation using publicly available information. If the public information on wages/employment exists only in aggregate and for students from specific college types, this method can utilize an indicator of low wages/unemployment—loan repayment default—that is available by college, combined with information on typical loan amounts held by graduates from multiple colleges, to determine the underlying economic conditions of individuals from the colleges. This method can extrapolate what wages and employment are likely to be to generate observed levels of default.

As a non-limiting example, data can be sourced or derived from Department of Education cohort default rates, IPEDS reports on typical loan amounts (by school), and other studies of the experiences of college graduates, and/or other agency datasets on employment and wages.

Various types of data may be known, including, for example, overall two-year cumulative cohort default rates, by year, for multiple college institutions; annual federal student loan amounts, by year, for multiple college institutions; wages for the general population and for college graduates, by age group; unemployment for the general population and for college graduates, by age group; and/or wages and unemployment patterns by school type and location for multiple points in the first 10 years after graduation for two college graduation cohorts.

Some types of data may not be known, including, for example, average wage and unemployment levels after graduation over time, by college.

The example methods described herein can be used to generate wage distributions and unemployment frequencies by college institution based on studies that have found that people tend to have trouble making their full student loan payments when those payments are somewhere between 7% to 12%—on average about 10%—of their adjusted gross income (AGI). Thus, for example, if a college whose graduates have a non-repayment rate of 15% and an average monthly student loan payment of $300, then approximately 15% of those in repayment from that college may have a monthly AGI of about $3,000 or less or be unemployed. This method can use public information on wage and unemployment rates and tailors the observed national distributions to multiple colleges so that the tailored distributions generate the observed default rates for the colleges. The processor can be configured to perform these calculations based on general wage and unemployment data or with data that reflect specific college types, both of which may be publicly available.

As a non-limiting example, the processor may be configured to perform this method in three steps:

1. Forecast average wage and unemployment rates and the distributions around those averages.

2. Forecast durations of unemployment and low wages (e.g., wage and unemployment turnover).

3. Tailor the averages and distribution for the colleges.

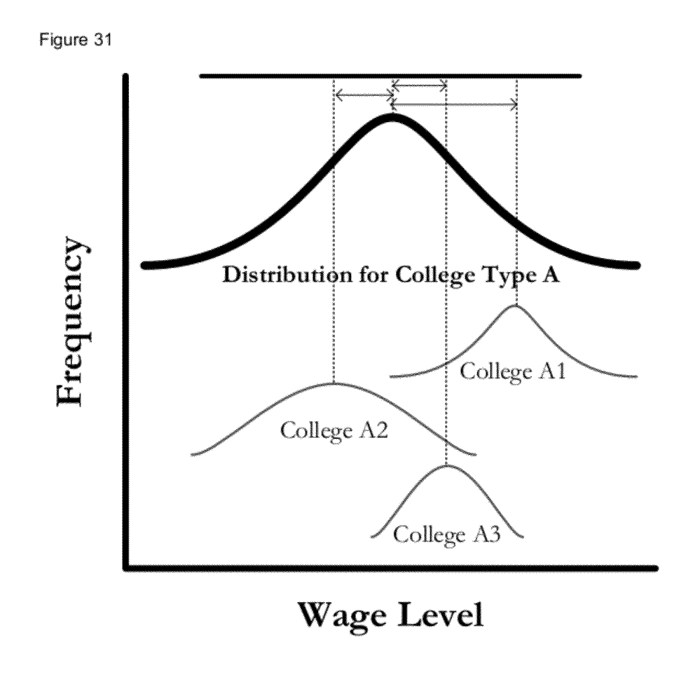

An example of this analysis is illustrated in FIG. 31.

Datasets

Several government sources publish employment and wage data in general and for specific subsets of the population. For example, the Decennial Census publishes comprehensive data on wages and labor force participation that can be divided by age, location, and other specific factors every 10 years. Additionally, both the Bureau of the Census's annual American Community Survey (ACS) and the Bureau of Labor Statistics' (BLS) Current Population Survey (CPS) include summary figures on wages and labor force participation by age or by educational attainment (but not both) for a sample of individuals. Furthermore, the Public Use Microdata Sample (PUMS) files that are used to generate the ACS and the Panel Survey of Income Dynamics (PSID) are also publicly available and include person-record data on income, labor force participation, educational attainment, and age. The National Longitudinal Survey of Youth (NLSY) also includes record-level data on these factors for persons aged 12-16 as of Dec. 31, 1996.

Some or all of these datasets can be used by the processor, alone or in combination, to generate general distributions of income and/or core analytical results. These datasets can also be used to corroborate regional or alternative data sources.

In some embodiments, the Department of Education's (ED) National Center for Education Statistics' (NCES) Baccalaureate and Beyond Longitudinal Studies (B&B) can be used to provide information concerning the employment experiences of recent college graduates and can also be used as the core data in this method.

Average and Distribution of Wages and Unemployment

The processor can be configured to calculate the average wages for college graduates at any given point in time. This calculation can include two sub calculations:

1. Calculating the average starting wages for different graduating cohorts.

2. Calculating how these average wages increase from their starting values.

The processor can be configured to calculate starting wages by examining how the starting wages changed between the two cohorts, by college type. For example, the change in starting wages can be determined through the following equation:

$$Δ {w}_{C}^{S} = \frac{{w}_{C , 2000}^{S} - {w}_{C , 1994}^{S}}{2000 - 1994}$$

where
   Δ=designates annual change,
   w^{S}_{c,y}=starting wage for college type c in year y

Because this measure uses two points in time, in some instances, it may be affected by year-to-year fluctuations in wages, but this may be mitigated by the fact that it does cover a six-year period. This analysis may yield a rate increase that is less than the rate of change of the consumer price index (CPI-U) over the same period.

The users of this method can validate (or alternatively use) wages from other data sources. In some embodiments, other data sources can be used for comparison to contemporary unemployment rates and other economic indicators to determine how starting wages may be influenced by current economic conditions.

The processor can be configured to calculate wages after graduation by examining wage growth in the years after graduation over time and relative to gross domestic product (GDP) growth (or wages at ages 23 and up using the other data sources). By analyzing the patterns of wage growth for the two cohorts in different economic circumstances, the processor can capture both the effects of experience/tenure and the economic climate:

w_{C}^{I,Y}=f(I,GDP_{Y},C)+ε_{I,Y,C}
where
   w^{i,y}_{c}=wages i years after graduation in year y for college type c,
   i=years after graduation,
   GDP_{y}=gross domestic product in year y,
   c=college type,
   ε=error term

For the first two years after graduation, both cohorts have reported data, but for the following years after graduation, only data for the 1992-93 graduating cohort exist. Thus, in the interest of efficiency, the processor can be configured to calculate a linear relationship between average wages and year after graduation and GDP:

ŵ_{C}^{I,Y}=α_{C}+β_{C}I+δ_{C}GDP+\hat{ε}_{I,Y,C}
where
   α_{c}, β_{c}, δ_{c}=parameters to be estimated,
   ̂=designates observed values

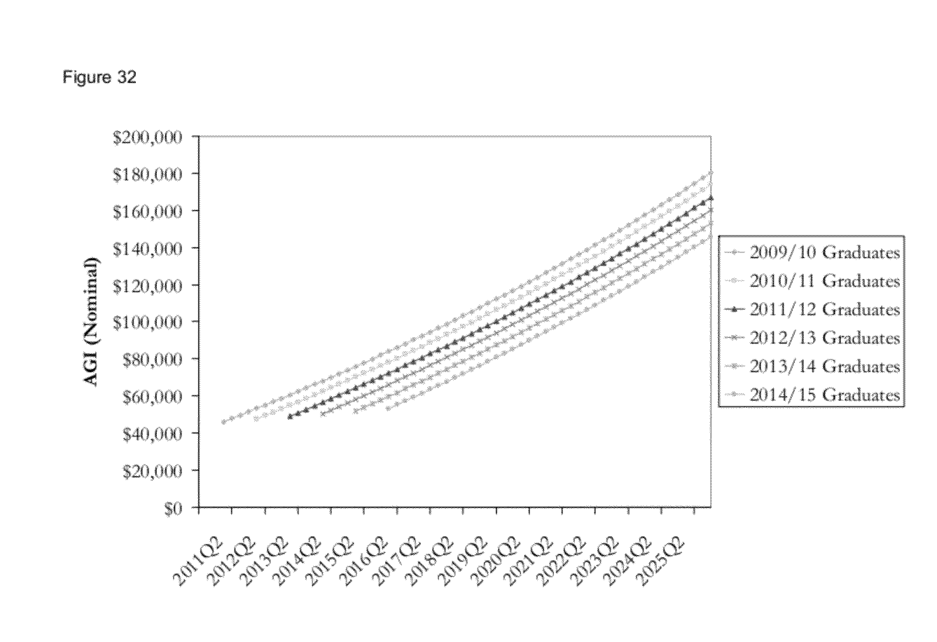

An example plot based on this equation is illustrated in FIG. 32. Using data from the two available cohorts, this reveals wage growth faster than GDP growth, thereby further explaining the wage gap. The processor can be configured to insert GDP forecasts and thereby forecast both starting wages and wage growth for future graduating cohorts.

The processor can be configured to measure unemployment in a similar manner, where the unemployment rates for recent college graduates are regressed on cohort, years after graduation, and unemployment for college graduates aged 25 and older, available from the BLS:

û_{C}^{I,Y}=α_{C}+β_{C}I+δ_{C}U_{Y}^{G,25+}+\hat{ε}_{I,Y,C}
where
   u^{i,y}_{c}=unemployment i years after graduation in year y for college type c,
   U^{g,a+}_{y}=national unemployment for college graduates aged a or over in year y,
   α_{c}, β_{c}, δ_{c}=parameters to be estimated,
   ̂=designates observed values

The processor can be configured to calculate distributions around these averages in a similar manner and use them for the average wages and unemployment above so long as the B&B studies report both the averages and distributions for the cohorts in the years. In this method, the processor can be configured to regress the distributions (e.g., the ratio of the standard deviation to the average) on the number of years after graduation and on underlying economic conditions, by cohort.

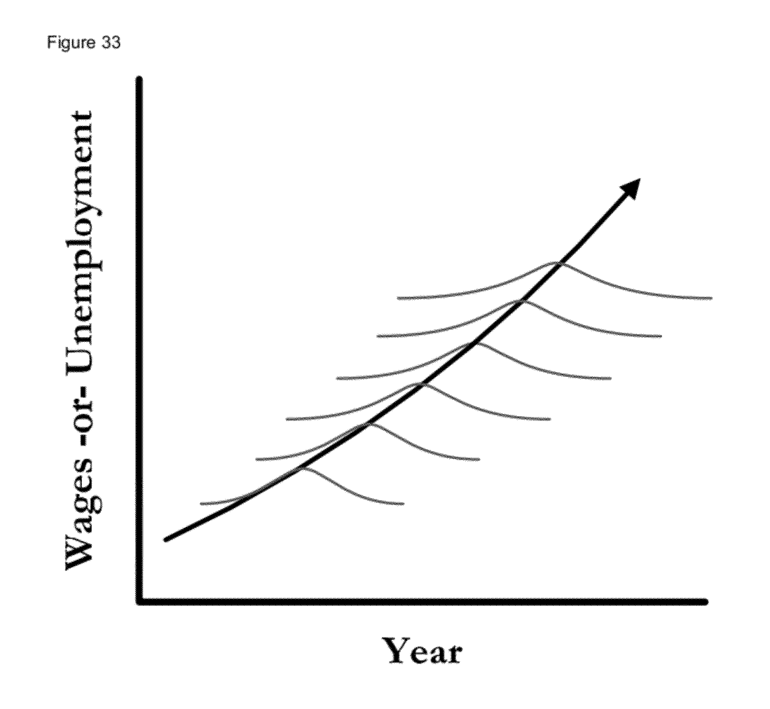

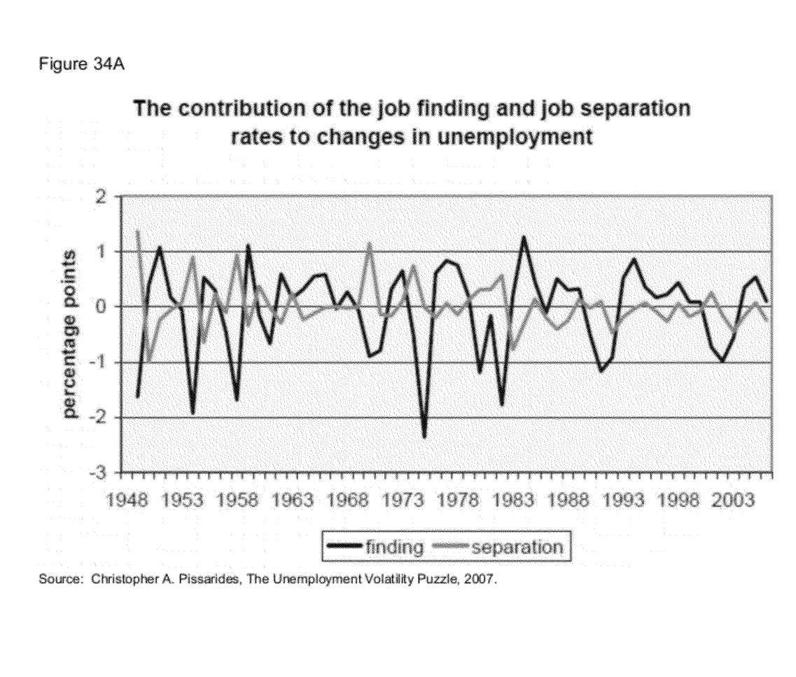

After this analysis, the processor can determine the average and distribution of wage levels and unemployment rates for years after graduation, by college type, forecasted using forecasts of GDP and graduate unemployment. An example plot using this analysis is illustrated in FIG. 33.

Duration of Low Wages and Unemployment

Once the averages and distributions of wages and unemployment have been calculated at any given time for any given cohort and college type, the processor can be configured to forecast how an individual fits into these distributions. That is, for example, are the same people unemployed from one period to the next? Or, for example, are different people unemployed in each period? This may be relevant in the context of a line of credit that may have time limits on use for any given individual to see how many people are expected to reach those time limits. (Alternatively, if there are no time limits, then using the distributions above would yield the final answer.)

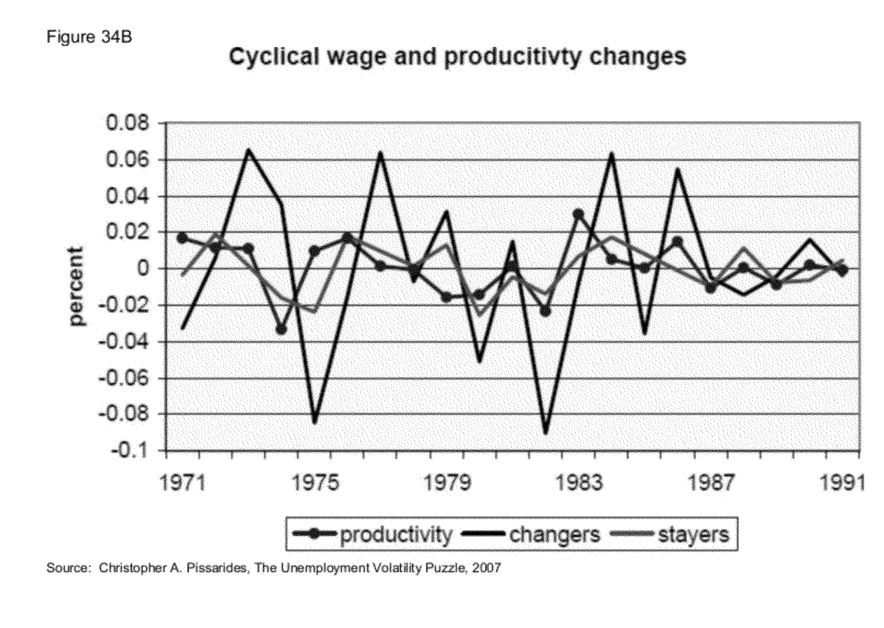

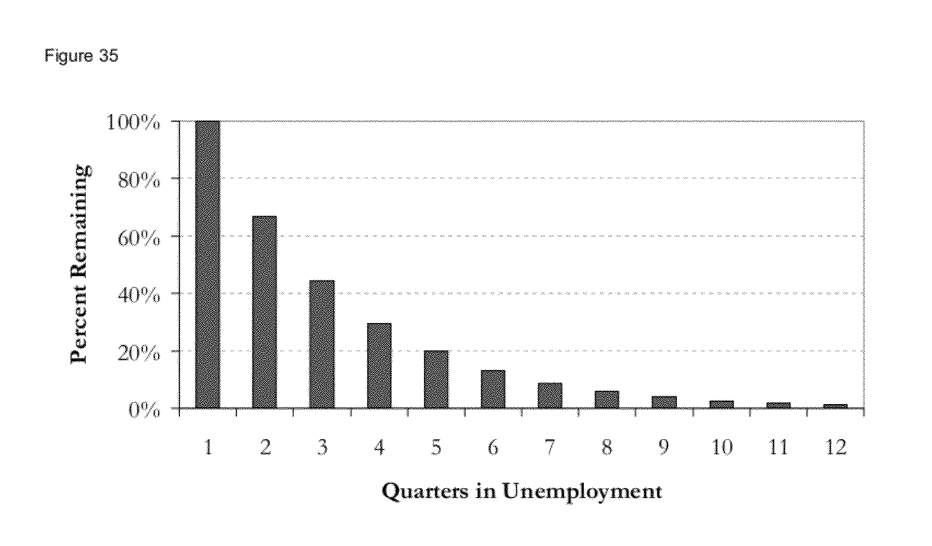

For wages, the B&B studies do not examine wage volatility in depth. Thus, this method can use the standard, academic studies on wage volatility analysis, such as those illustrated in FIGS. 34A and 34B. The processor can be configured to calculate the duration that a person has wages below a threshold or remains unemployed using a Monte Carlo simulation based on volatility parameters, combined with the average rates already determined. Because this varies by wage level, by unemployment rate, by college type, and by the underlying economic circumstances, results can vary significantly in various situations and by forecast. An example of this calculation is illustrated in FIG. 35.

The processor can be configured to generate duration curves for wage thresholds and unemployment rates that can be applied to future cohorts and projected economic conditions. These can result in forecasts of the proportion of college graduates, by college, who have wages below a certain threshold or who are unemployed for any period after graduation for any cohort, and what proportion of those below the thresholds or unemployed are existing or new.

Tailoring Wages and Unemployment for Colleges

The processor can be configured to take the general wage and employment distributions, either in general or by college type, and then to apply them to individual colleges. An example method of this module is to use the intersection of cumulative, two-year cohort default rates published by the Department of Education for the colleges and the wage and unemployment distributions determined above. For example, this method can start with the distributions for the college types and then adjust these for an individual college to find the combinations of mean and variance that generate the default rates observed for that college. Because these default rates can be generated by using an infinite number of combinations of mean and variance, the processor can further adjust the distributions through a search algorithm so that, when they are summed together, they generate the observed distributions for their college type.

As non-limiting examples, the iterative search algorithm executing on the processor can operate in some or all of the following four ways:

1. Fix the variances of wages and unemployment for a given college based on the population-adjusted variances for their college type, and scale the mean up or down to generate the observed default rate.

2. Fix mean wage and unemployment levels based on the mean (and variance of the mean) for the associated college type, and adjust the college-specific variances to generate the observed default rate.

3. Vary the mean levels by college by using the z-score of that college's default rate and applying it to the college type's means and variances, and then adjust the variances for that college to yield the observed default rate.

4. Vary the mean levels by college by using the z-score of that college's default rate and applying it to the college type's means and variances, and then adjust the variances for systematically for multiple colleges so that the sum of the distributions for multiple colleges match the overall observed distributions.

While any of these types can be used in various embodiments, the first three may reduce to the method employed by examining historical loan non-repayment at or near the default rate, so they may provide the same or similar mean results but with different elasticities. Thus, to explore a comparison, then the fourth option may be used.

The following example illustrates a simplified version of how this is can be performed for the wage distribution. For example, College A may be a liberal arts institution that has a two-year cumulative default rate of 12%—which translates to a z-score of +1.5 when compared to other liberal arts institutions—and an average monthly loan payment for its graduates of $150. It may be assumed that students who graduate from liberal arts institutions tend to have an average unemployment rate of 7% in their first year after college and have an average monthly wage of $2,000, and the wage distribution for liberal arts institutions has a standard deviation of 10%, or $200. For example, it may be assumed that College A students therefore also have an average unemployment rate of 7% after college.

Using the following example steps, the processor can be configured to determine what the wage distribution can be to generate an extra 5% of those whose incomes have been below $150*10=$1,500.

1. The first step is to determine the mean wage for students at College A. Based on the liberal arts mean of $2,000 and standard deviation of $200 and College A's z-score of +1.5, the mean would be $2,000−1.5*$200=$2,000−$300=$1,700.

2. The next step is to determine the starting point for the variation in wages at College A. The population-adjusted variation for liberal arts colleges may be used. In this case, if liberal arts institutions have 100,000 students and a standard deviation of $200, and College A has 10,000 students, then College A's starting standard deviation would be $200*SQRT(10,000)/SQRT(100,000)=$63. This would likely be an underestimate of the variance for College A because of the systematic differences between colleges, rather than colleges being a random sample within the college types.

3. The next step is to repeat this exercise for multiple other liberal arts institutions.

4. The last step is to then use a Monte Carlo search algorithm that simulates the wages for multiple individuals at the institutions based on the derived mean and variance, groups them together, and then determines if the resultant aggregate distribution matches the distribution for Liberal Arts colleges derived from the B&B studies.
a. If the resultant variance is too narrow, then increase the college's standard deviation by 1% and perform the calculation again. For College A, this would be $64.
b. If the resultant variance is too broad, then decrease the college's standard deviation by 1% and perform the calculation again. For College A's, this would be $62.
c. Continue until the mean and standard deviation of the sum of the college's distribution equals or substantially equals the reported mean and variation.

This method can yield a mean and standard deviation in wages and unemployment for the colleges, as well as the typical duration of time either with a wage less than a user-specified threshold or in unemployment. This data can be used by the processor to determine the frequency with which college graduates are unemployed or have low wages at various points in the student loan repayment period.

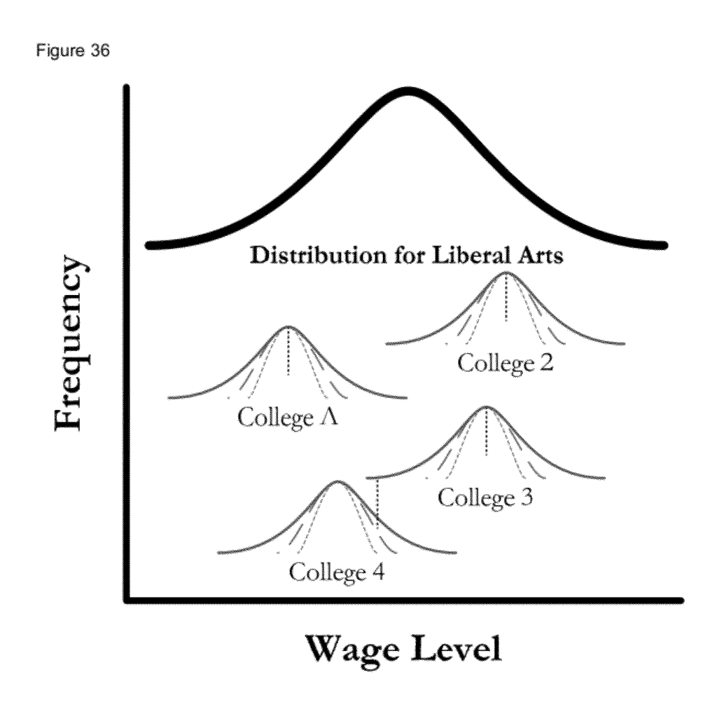

An example plot of this analysis is illustrated in FIG. 36. As with the loan non-repayment module, the processor can translate these frequencies into the expected value of loan non-repayment in various periods for the colleges, which can be combined into a net present value using standard cash flow discounting procedures. Then, after adjustment for adverse selection and the college's graduation rate, the actuarially fair fee that would be charged to enrolled students to purchase the associated product can be determined.

In some embodiments, variations can include adjusting the average wage distribution to reflect local wage levels, degree distribution (e.g., proportion of business majors), and other factors that may influence economic outcomes.

The systems and methods described herein can be implemented in software or hardware or any combination thereof.

The methods can be implemented in a computer program product accessible from a computer-usable or computer-readable storage medium providing program code for use by or in connection with a computer or any instruction execution system. A computer-usable or computer-readable storage medium can be any apparatus that can contain or store the program for use by or in connection with the instruction execution system, apparatus, or device. The described features can be implemented in one or more computer program products that are executable on a processing system including at least one programmable processor coupled to receive data and instructions from, and to transmit data and instructions to, a data storage system, at least one input device, and at least one output device.

A data processing system suitable for storing and/or executing the corresponding program code can include at least one processor coupled directly or indirectly to memory elements. Input/output (I/O) devices (including but not limited to keyboards, displays, pointing devices, etc.) can be coupled to the system. Network adapters may also be coupled to the system to enable the data processing system to become coupled to other data processing systems or remote printers or storage devices through intervening private or public networks. To provide for interaction with a user, the features can be implemented on a computer having a display device such as a CRT (cathode ray tube), LCD (liquid crystal display), or other type of monitor for displaying information to the user and a keyboard and an input device, such as a mouse or a trackball by which the user can provide input to the computer.

A computer program can be a set of instructions that can be used, directly or indirectly, in a computer. The systems and methods described herein can be implemented using programming languages such as Flash, JAVA (Registered Trademark), C++, C, C#, Visual Basic, JavaScript, PHP, XML, HTML etc., or a combination of programming languages, including compiled or interpreted languages, and it can be deployed in any form, including as a stand-alone program or as a module, component, subroutine, or other unit suitable for use in a computing environment. The software can include, but is not limited to firmware, resident software, microcode, etc. Protocols such as SOAP/HTTP may be used in implementing interfaces between programming modules. The components and functionality described herein may be implemented on any desktop operating system such as different versions of Microsoft Windows, Apple Mac, Unix/X-Windows, Linux, etc., executing in a virtualized or non-virtualized environment, using any programming language suitable for desktop software development.

Suitable processors for the execution of a program of instructions include, by way of example, both general and special purpose microprocessors, and the sole processor or one of multiple processors or cores, of any kind of computer. A processor may receive instructions and data from a read-only memory or a random access memory or both. Processor may include any processing circuitry or control circuitry operative to control the operations and performance of an electronic device.

The processor may also include, or be operatively coupled to communicate with, one or more data storage devices for storing data files; such devices include magnetic disks (including internal hard disks and removable disks), magneto-optical disks, optical disks, and/or flash storage. Storage devices suitable for tangibly embodying computer program instructions and data can include all forms of non-volatile memory, including, for example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits). Any of the different types of inputs, source data, intermediate calculation data, and/or final result data described herein can be stored in the one or more data storage devices and subsequently accessed by the processor.

The methods and systems described herein can be implemented using one or more virtual machines operating alone or in combination with each other. Any applicable virtualization solution can be used for encapsulating a physical computing machine platform into a virtual machine that is executed under the control of virtualization software running on a hardware computing platform, or host. The virtual machine can have both virtual system hardware and guest operating system software.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

One or more embodiments of the invention may be practiced with other computer system configurations including hand-held devices, microprocessor systems, microprocessor-based or programmable consumer electronics, minicomputers, mainframe computers and the like. The invention may also be practiced in distributing computing environments where tasks are performed by remote processing devices that are linked through a network.

It will be appreciated that, although specific embodiments of the invention have been described herein for purposes of illustration, various modifications may be made without departing from the spirit and scope of the invention.

Various numerical values, such as percentages, are provided throughout this disclosure. Some of these values are presented as endpoints of a range, such as 100% or 0%. It will be appreciated that any of these numerical values disclosed may be modified without departing from the spirit and scope of the invention and other numerical values having the same or similar practical effect may be substituted as appropriate.

What is claimed is:

1. A non-transitory computer readable storage medium comprising code executable by a processor for performing a method, the method comprising:
receiving input from a user comprising one or more characteristics relating to a loan repayment program, the loan repayment program comprising a line of credit for a program applicant;
calculating one or more characteristics of the loan repayment program applicant based on extrapolated post-secondary institution enrollment data; and
calculating an actuarially fair fee for the loan repayment program based on the one or more calculated characteristics of the loan repayment program applicant and the one or more characteristics relating to the loan repayment program.

2. The non-transitory computer readable storage medium of claim 1, the method further comprising generating a prototype non-repayment pattern based on the received input.

3. The non-transitory computer readable storage medium of claim 2, the method further comprising generating the prototype non-repayment pattern based on additional data selected from historical income and unemployment rates.

4. The non-transitory computer readable storage medium of claim 2, the method further comprising adjusting the prototype non-repayment pattern based on economic conditions and post-secondary institution characteristics.

5. The non-transitory computer readable storage medium of claim 2, the method further comprising adjusting the prototype non-repayment pattern based on college characteristics.

6. The non-transitory computer readable storage medium of claim 2, the method further comprising adjusting the prototype non-repayment pattern based on underlying economic conditions.

7. The non-transitory computer readable storage medium of claim 1, the method further comprising calculating one or more characteristics of a loan repayment program applicant based on extrapolated post-secondary institution graduation data.

8. The non-transitory computer readable storage medium of claim 1, the method further comprising calculating a net obligation to a purchase time to generate the actuarially fair fee.

9. A system for providing a loan repayment program comprising:
an enrollment module configured to extrapolate enrollment information for a year of a post-secondary institution after the first;
a graduation module configured to extrapolate graduation information for a post-secondary institution; and
a processor configured to calculate an actuarially fair cost of insurance based on output of the enrollment and graduation modules.

10. The system of claim 9, further comprising a prototype loan non-repayment module.

11. The system of claim 10, further comprising a prototype modification module.

12. The system of claim 9, further comprising an extrapolation module for extrapolating enrollment information for a year of college after the first by calculating an enrollment percentage of students remaining from a first year in subsequent years.

13. The system of claim 12, further comprising applying the calculated enrollment percentage to overall enrollment to generate a total student count.

14. A computerized method for calculating an expected cost of a loan repayment insurance program, comprising:
storing post-secondary institution enrollment data in a data storage device;
storing post-secondary institution graduation data in the data storage device;
receiving input from a user comprising one or more characteristics relating to a loan repayment program, the loan repayment program comprising a line of credit for a program applicant;
storing the user input in the data storage device;
calculating a characteristic of the program applicant based on extrapolation of the stored post-secondary institution enrollment data;
calculating a characteristic of the program applicant based on extrapolation of the stored post-secondary institution graduation data; and
calculating an actuarially fair fee for the loan repayment insurance program based on the calculated loan applicant characteristics.

15. The method of claim 14, further comprising calculating the average net present value of cash flows associated with providing a student loan repayment program.

16. The method of claim 14, further comprising calculating a net present value of an obligation by summing the net present value of an expected cash outflow and a net present value of an expected cash inflow.

17. The method of claim 14, further comprising calculating enrollment and graduation characteristics of students for multiple years in college based on publicly available data

18. The method of claim 14, wherein the loan repayment insurance program is an interest-free line of credit that covers student loan repayments.

19. The method of claim 14, further comprising guaranteeing payment of underlying loan obligations.

20. The method of claim 14, further comprising adjusting a prototype non-repayment pattern based on economic conditions and post-secondary institution characteristics.
